(19) United States
(12) Patent Application Publication
(10) Pub. No.: US 2023/0383582 A1
(43) Pub. Date: Nov. 30, 2023

(54) CASE ASSEMBLY AND REFRIGERATION DEVICE

(71) Applicants: GUANGDONG MIDEA WHITE HOME APPLIANCE TECHNOLOGY INNOVATION CENTER CO. LTD., FOSHAN (CN); HEFEI MIDEA REFRIGERATOR CO., LTD., HEFEI (CN); HEFEI HUALING CO., LTD., HEFEI (CN); MIDEA GROUP CO., LTD., FOSHAN (CN)

(72) Inventors: Lei ZHONG, FOSHAN (CN); Guo ZENG, FOSHAN (CN); Xuekang LIU, FOSHAN (CN); Haike LI, FOSHAN (CN)

(21) Appl. No.: 18/366,573

(22) Filed: Aug. 7, 2023

Related U.S. Application Data
(63) Continuation-in-part of application No. PCT/CN2022/074402, filed on Jan. 27, 2022.

(30) Foreign Application Priority Data
Feb. 9, 2021 (CN) 202110179364.0
Apr. 22, 2021 (CN) 202110437107.2
Apr. 22, 2021 (CN) 202110437114.2
Apr. 22, 2021 (CN) 202110438278.7
Apr. 22, 2021 (CN) 202110438279.1
Apr. 22, 2021 (CN) 202120844077.2
Apr. 22, 2021 (CN) 202120844078.7
Apr. 22, 2021 (CN) 202120844332.3
Apr. 22, 2021 (CN) 202120844361.X

(51) Int. Cl. E05D 3/18; F25D 23/02; E05D 7/085

(52) U.S. Cl. CPC E05D 3/18; F25D 23/02; E05D 7/085; F25D 2323/024

(57) ABSTRACT

A case assembly includes: a case, defining a receiving space having an opening; a door, configured to block the opening; and a hinge assembly, pivotally connect the case to the door. The door has an inner edge, an outer edge, a first reference plane and a second reference plane. When the door is in a closed state, the inner edge is located on and extend along the first reference plane, and the first reference plane is parallel to a plane in which the opening is located. When the door is in a closed state, the outer edge is located on and extend along the second reference plane, and the second reference plane is perpendicular to the plane in which the opening is located, the first reference plane and the second reference plane stay stationary with respect to the case while the door is being opened.

### CROSS-REFERENCES TO RELATED APPLICATIONS

The present application is a continuation-in-part application of the international patent application No. PCT/CN2022/074402, filed on Jan. 27, 2022, which claims the priority of the Chinese patent application No. 202110179364.0, filed on Feb. 9, 2021, submitted to the China National Intellectual Property Administration; the Chinese patent application No. 202110437114.2, filed on Apr. 22, 2021, submitted to the China National Intellectual Property Administration; the Chinese patent application No. 202110438278.7, filed on Apr. 22, 2021, submitted to the China National Intellectual Property Administration; the Chinese patent application No. 202120844078.7, filed on Apr. 22, 2021, submitted to the China National Intellectual Property Administration; the Chinese patent application No. 202120844332.3, filed on Apr. 22, 2021, submitted to the China National Intellectual Property Administration; the Chinese patent application No. 202110438279.1, filed on Apr. 22, 2021, submitted to the China National Intellectual Property Administration; the Chinese patent application No. 202120844077.2, filed on Apr. 22, 2021, submitted to the China National Intellectual Property Administration; the Chinese patent application No. 202110437107.2, filed on Apr. 22, 2021, submitted to the China National Intellectual Property Administration; and the Chinese patent application No. 202120844361.X, filed on Apr. 22, 2021, submitted to the China National Intellectual Property Administration; and the contents of which are incorporated herein by their entireties.

### FIELD

The present disclosure relates to a case assembly and a refrigeration device.

### BACKGROUND

For a case assembly arranged with a door and a case, when the door is open relative to the case, the door may compress the case, and therefore, the door may extend beyond a side of the case assembly. In this case, the case may be damaged, and interference with an environment in which the case assembly is mounted may be caused. For example, while performing an embedded mounting process, a portion of the door that extends beyond the side of the case assembly may interfere with a wall into which the case assembly is mounted.

### SUMMARY

The present disclosure provides a case assembly to solve the problem that the door, while being opened, compresses the case and extends beyond the side of the case assembly.

A case assembly includes: a case, defining a receiving space having an opening; a door, configured to block the opening; and a hinge assembly, disposed body at a pivot side of the case and configured to pivotally connect the case to the door. The door has an inner edge and an outer edge at the pivot side, the door has a first reference plane and a second reference plane; when the door is in a closed state relative to the case, the inner edge is located on and extend along the first reference plane, and the first reference plane is parallel to a plane in which the opening is located; when the door is in a closed state relative to the case, the outer edge is located on and extend along the second reference plane, and the second reference plane is perpendicular to the plane in which the opening is located, the first reference plane and the second reference plane stay stationary with respect to the case while the door is being opened with respect to the case. A first hinge point and a second hinge point are formed on the hinge assembly; the second hinge point, compared to the first hinge point, is located further away from the outer edge; while the door is being opened, under an action of the hinge assembly, from a closed state with respect to the case to a position of a maximum opening angle with respect to the case, the first hinge point is configured to move from a starting position to a termination position, a point on the door is defined as a reference point, the reference point coincides with one of the starting position and termination position of the first hinge point, the coincided one of the starting position and termination position is located furthest away from the second reference plane, and the reference point is stationary with respect to the case while the door is being opened. A first perpendicular line is generated from the reference point to the outer edge; the reference point has a first perpendicular distance, along the first perpendicular line, to the outer edge; a second perpendicular line is generated from the reference point to the inner edge; the reference point has a second perpendicular distance, along the second perpendicular line, to the inner edge; a third angle is generated between the first perpendicular line and the first reference plane, a fourth angle is generated between the second perpendicular line and the first reference plane. When the door is being opened from the closed state to a position of a first opening angle relative to the case, each of the first perpendicular distance and the second perpendicular distance is gradually decreased, the third angle is within a range of 0 degrees to 90 degrees and is gradually decreased, and the fourth angle is in a range of 0 degrees to 90 degrees and is gradually increased.

From the perspective of motion relationships for analyzing the case assembly of the present disclosure, motion tendencies of the two hinge points correspond to motions of the door relative to the case. The motions include rotation and movement. For the movement, the door has a tendency of moving away from the first reference plane and the second reference plane. The movement counteracts the tendency of the door compressing the case and the tendency of the door exceeding the side of the case assembly, while the door being rotating. Therefore, for the door assembly of the present disclosure, the door may not excessively compress the case or extends excessively far beyond the side of the case assembly.

### BRIEF DESCRIPTION OF THE DRAWINGS

In order to more clearly illustrate technical solutions in embodiments of the present disclosure, accompanying drawings for describing the embodiments will be introduced in brief in the following. Apparently, the following described accompanying drawings show only some of the embodiments of the present disclosure. Any ordinary skilled person in the art may obtain other drawings based on the following drawings without any creative work.

FIG. 1 is a structural schematic view of a case assembly according to a first embodiment of the present disclosure.

FIG. 2 is a schematic view of a motion relationship of the door moving relative to the case in the case assembly in the art.

FIG. 3 is a schematic view of a movement trajectory of a first edge of the case assembly shown in FIG. 1 in the first embodiment of the present disclosure.

FIG. 4 is a schematic view of an angle of the door being open relative to the case and the movement trajectory of the first edge of the case assembly shown in FIG. 1 in the first embodiment of the present disclosure.

FIG. 5 is a schematic view of a movement trajectory of a reference point of the case assembly shown in FIG. 1 in the first embodiment of the present disclosure.

FIG. 6 is a schematic view of a value range of an inner reference point of the case assembly shown in FIG. 1 in the first embodiment of the present disclosure.

FIG. 7 is a schematic view of a value range of an outer reference point of the case assembly shown in FIG. 1 in the first embodiment of the present disclosure.

FIG. 8 is a structural schematic view of the case assembly according to a second embodiment of the present disclosure.

FIG. 9 is a structural schematic view of a hinge shaft of the hinge assembly of the case assembly shown in FIG. 8 in the second embodiment of the present disclosure.

FIG. 10 is a structural schematic view of a hinge slot of the hinge assembly of the case assembly shown in FIG. 8 in the second embodiment of the present disclosure.

FIG. 11 is a schematic view showing a state of the hinge assembly, when the door being in a closed state relative to the case, of the case assembly shown in FIG. 8 in the second embodiment of the present disclosure.

FIG. 12 is a schematic view showing a state of the hinge assembly, when the door being opened and at a location of a first opening angle relative to the case, of the case assembly shown in FIG. 8 in the second embodiment of the present disclosure.

FIG. 13 is a schematic view showing a state of the hinge assembly, when the door being opened and having a second opening angle relative to the case, of the case assembly shown in FIG. 8 in the second embodiment of the present disclosure.

FIG. 14 is a schematic view showing a state of the hinge assembly, when the door being opened and having a third opening angle relative to the case, of the case assembly shown in FIG. 8 in the second embodiment of the present disclosure.

FIG. 15 is a cross-sectional view of the case assembly according to a third embodiment of the present disclosure.

FIG. 16 is an enlarged view of a portion of the hinge assembly, when the door body being in the closed state, of the case assembly in the third embodiment of the present disclosure.

FIG. 17 is an enlarged view of a portion of the hinge assembly, when the door being at the first opening angle relative to the case, of the case assembly in the third embodiment of the present disclosure.

FIG. 18 shows a function of the angle between the moving direction and the first reference plane being varied as the opening angle of the door relative to the case varies, for the case assembly in the third embodiment of the present disclosure.

FIG. 19 is an enlarged view of a portion of the hinge assembly, when the door being at the second opening angle relative to the case, of the case assembly in the third embodiment of the present disclosure.

FIG. 20 shows a function of a perpendicular distance between the reference point and the edge being varied as the opening angle of the door relative to the case varies, for the case assembly in the third embodiment of the present disclosure.

FIG. 21 shows a function of the angle between the first reference plane and the perpendicular line from the reference point to the edge being varied as the opening angle of the door relative to the case varies, for the case assembly in the third embodiment of the present disclosure.

FIG. 22 shows a function of the distance of the door exceeding the case being varied as the door varying from the closed state to a state of having the first opening angle relative to the case, for the case assembly in the third embodiment of the present disclosure.

FIG. 23 shows a function of the distance of the door compressing the case being varied as the door varying from the closed state to a state of having the first opening angle relative to the case, for the case assembly in the third embodiment of the present disclosure.

FIG. 24 shows a function of the distance of the door exceeding the case being varied as the door varying from the state of having the first opening angle relative to the case to the state of having the second opening angle relative to the case, for the case assembly in the third embodiment of the present disclosure.

FIG. 25 shows a function of the distance of the door compressing the case being varied as the door varying from the state of having the first opening angle relative to the case to the state of having the second opening angle relative to the case, for the case assembly in the third embodiment of the present disclosure.

FIG. 26 shows a function of the angle between the moving direction and the plane in which the rear wall is arranged being varied as the opening angle of the door relative to the case varies, for the case assembly in the third embodiment of the present disclosure.

FIG. 27 is an enlarged view of a portion of the hinge assembly, when the door being at the closed state, of the case assembly in a fourth embodiment of the present disclosure.

FIG. 28 is an enlarged view of a portion of the hinge assembly, when the door having the first opening angle relative to the case, of the case assembly in the fourth embodiment of the present disclosure.

FIG. 29 shows a function of the first angle and the second angle being varied as the opening angle of the door relative to the case varies, for the case assembly in the fourth embodiment of the present disclosure.

FIG. 30 is an enlarged view of a portion of the hinge assembly, when the door having the second opening angle relative to the case, of the case assembly in the fourth embodiment of the present disclosure.

FIG. 31 is an enlarged view of a portion of the hinge assembly, when the door being at the closed state, of the case assembly in a fifth embodiment of the present disclosure.

FIG. 32 is an enlarged view of a portion of the hinge assembly, when the door having the first opening angle relative to the case, of the case assembly in the fifth embodiment of the present disclosure.

FIG. 33 shows a function of the first angle and the second angle being varied as the opening angle of the door relative to the case varies, for the case assembly in the fifth embodiment of the present disclosure.

FIG. 34 is an enlarged view of a portion of the hinge assembly, when the door having the second opening angle relative to the case, of the case assembly in the fifth embodiment of the present disclosure.

FIG. 35 is an enlarged view of a portion of the hinge assembly, when the door being at the closed state, of the case assembly in a sixth embodiment of the present disclosure.

FIG. 36 is an enlarged view of a portion of the hinge assembly, when the door having the first opening angle relative to the case, of the case assembly in the sixth embodiment of the present disclosure.

FIG. 37 shows a function of the first angle and the second angle being varied as the opening angle of the door relative to the case varies, for the case assembly in the sixth embodiment of the present disclosure.

FIG. 38 is an enlarged view of a portion of the hinge assembly, when the door having the second opening angle relative to the case, of the case assembly in the sixth embodiment of the present disclosure.

FIG. 39 is an enlarged view of a portion of the hinge assembly, when the door being at the closed state, of the case assembly in a seventh embodiment of the present disclosure.

FIG. 40 is an enlarged view of a portion of the hinge assembly, when the door having the first opening angle relative to the case, of the case assembly in the seventh embodiment of the present disclosure.

FIG. 41 is an enlarged view of a portion of the hinge assembly, when the door having the second opening angle relative to the case, of the case assembly in the seventh embodiment of the present disclosure.

FIG. 42 is a schematic view of the movement trajectory of the edge in the case assembly according to an embodiment of the present disclosure.

FIG. 43 is a schematic view of the opening angle of the door relative to the case and the movement trajectory of the edge of the case assembly according to an embodiment of the present disclosure.

FIG. 44 is an enlarged view of the hinge assembly, when the door is being closed with respect to the case, of the case assembly according to an embodiment of the present disclosure.

FIG. 45 is an enlarged view of the hinge assembly, when the door is being opened with respect to the case, of the case assembly according to an embodiment of the present disclosure.

### DETAILED DESCRIPTION OF THE DISCLOSURE

The technical solutions in the embodiments of the present disclosure will be described clearly and completely in the following by referring to the accompanying drawings for the embodiments of the present disclosure. Apparently, the described embodiments show only a part of, but not all of, the embodiments of the present disclosure. All other embodiments obtained by any ordinary skilled person in the art, based on the embodiments in the present disclosure and without any creative work, shall fall within the scope of the present disclosure.

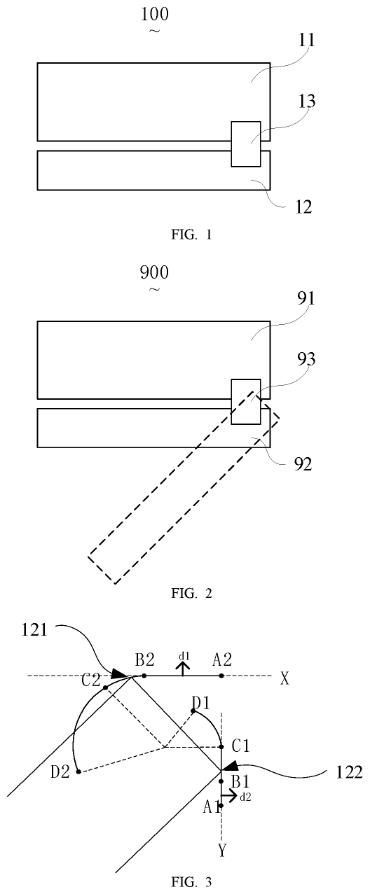

As shown in FIG. 1, FIG. 1 is a structural schematic view of a case assembly according to a first embodiment of the present disclosure. A case assembly 100, in the present embodiment, includes a box 11, a door 12, and a hinge assembly 13. The case 11 is configured to define a receiving space having an opening. The door 12 is configured to block the opening. The hinge assembly 13 is disposed at a pivot side of the case 11 and is configured to pivotally connect the case 11 to the door 12. The door 12 may be opened or closed relative to the case 11 under the action of the hinge assembly 13.

The hinge assembly, which enables the door to rotate relative to the box, may be configured in various forms. Configuration of the hinge assembly determines a relative motion relationship between the door and the case. For a case assembly 900 in the art, as shown in FIG. 2, FIG. 2 is a schematic view of the motion relationship of the door moving relative to the case in the case assembly in the art. When the door body 92 is opened to reach a position of a certain angle relative to the case, the door 92 compresses a case 91 and extends beyond a side of the case assembly 900. The side of the case assembly 900 may be a side of the case 91 or a side of the door 92 when the door 92 is in a closed state (closed relative to the case 91). Apparently, the hinge assembly 93 in the art cannot solve the technical problem as described herein.

In the present disclosure, a movement trajectory of an edge of the door may be defined to alleviate the problem of the door compressing the case and extending beyond the side of the case assembly. Based on a principle of calculating relative motion, the relative motion relationship between the door and the case may be determined based on the movement trajectory of the edge, and further, a trajectory of a fixed point on the case or on the door may be determined. Subsequently, configuration of the hinge assembly may be determined inversely based on the movement trajectory of the fixed point. Therefore, any hinge assembly, which allows the movement trajectory of the edge as described in the present disclosure to be achieved, shall be covered by the scope of the present disclosure.

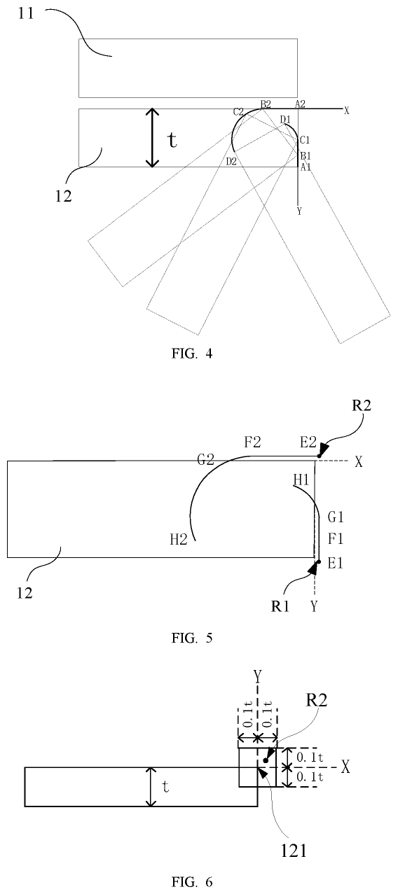

As shown in FIG. 3 and FIG. 4, FIG. 3 is a schematic view of a movement trajectory of a first edge of the case assembly shown in FIG. 1 in the first embodiment of the present disclosure, and FIG. 4 is a schematic view of an angle of the door being open relative to the case and the movement trajectory of the first edge of the case assembly shown in FIG. 1 in the first embodiment of the present disclosure.

In the present embodiment, the door 12 has an inner edge 121 and an outer edge 122 on the pivot side. When the door 12 is in the closed state relative to the case 11, the inner edge 121 is disposed closer to the case 11 than the outer edge 122. In the present embodiment, a first reference plane X and a second reference plane Y are further defined. The first reference plane X passes through, while the door is in the closed state, the inner edge 121 (for example, the inner edge 121 is located on and extending on the first reference plane X) and is parallel to a plane on which the opening is located. The second reference plane Y passes through, while the door is in the closed state, the outer edge 122 (for example, the outer edge 122 is located on and extending on the first reference plane Y) and is perpendicular to the plane on which the opening is located.

In a process of the door 12 being opened, under the action of the hinge assembly 13, from the closed state relative to the case 11 to a position having the first opening angle relative to the case 11, the inner edge 121 moves along a first inner edge trajectory A2B2 towards a side of the second reference plane Y facing the opening, and the outer edge 122 moves along a first outer edge trajectory A1B1 towards the first reference plane X. The first reference plane X and the second reference plane Y do not move as the door 12 moves and are fixed reference planes. As the door 12 and the case 11 are pivotally connected with each other, while the door 12 is being opened, a moving direction of the inner edge 121 relative to the second reference plane Y, and a moving direction of the outer edge 122 relative to the first reference plane X must be the directions as described in the above.

Further, for the movement of the outer edge 122 and the inner edge 121 in their respective directions, the first outer edge trajectory A1B1 has a radius of curvature of not less than 5t, and a distance of the first outer edge trajectory A1B1 exceeding a side of the second reference plane Y away from the opening is not greater than a first predetermined distance d1. The first inner edge trajectory A2B2 has a radius of curvature of not less than 100t, and a distance of the first inner edge trajectory A2B2 exceeding beyond a side of the first reference plane X facing towards the opening is not greater than a second predetermined distance d2. The t is a thickness of the door.

In the present embodiment, the radius of curvature of each movement trajectory is defined, and the distance of each movement trajectory exceeding the respective reference plane is defined, such that the edges may move smoothly and may not move beyond a predetermined range. In detail, a minimum value of the radius of curvature of the first outer edge trajectory A1B1 and a minimum value of the radius of curvature of the first inner edge trajectory A2B2 are defined. That is, when the radius of curvature is set to be the minimum value, the door 12 may not significantly compress the case 11, and the door 12 may not excessively extend beyond the side of the case assembly. Moreover, when the radius of curvature is set to be infinity, the moving trajectory may be a straight line. In the case that each of the two trajectories is a straight line, the door 12 may be opened to reach a position having a maximum of 90 degrees relative to the case 11.

In the above, while defining the radius of curvature, the thickness of the door t is taken as a reference, the radius of curvature of the first outer edge trajectory A1B1 is not less than 5t, and the radius of curvature of the first inner edge trajectory A2B2 is not less than 100t. This is because the thickness of the door t determines the extent of the door 12 moving relative to the case 11 when the door 12 is being opened. Apparently, as the door 12 is thicker, the radius of curvature of the movement trajectory of the edge is greater.

A value of the first predetermined distance d1 determines the extent to which the outer edge 122 may exceed the side of the case assembly 100. In practice, the outer edge 122 is allowed to exceed the side of the case assembly 100 by a certain extent. For example, in a case when the case assembly is embedded into a wall for use, a certain gap is defined between the case 11 and the wall into which the case assembly is embedded. The gap allows the outer edge 122 to exceed the side of the case assembly 100 by a certain extent.

Similarly, a value of the second predetermined distance d2 determines the extent to which the inner edge 121 may compress the case 11. In practice, the inner edge 121 may be allowed to compress the case 11 to a certain extent. For example, the case 11 may be arranged with a deformable door seal, and therefore, the compression of a certain extent, applied by the inner edge 121 to the case 11, may be ignored.

In the present embodiment, the first predetermined distance d1 may be 3 mm, and the second predetermined distance d2 may be 1.5 mm.

In general, in the present embodiment, in the process of the door 12 being opened, under the action of the hinge assembly 13, from the closed state relative to the case 11 to the position having the first opening angle relative to the case 11, the inner edge 121 moves along the first inner edge trajectory A2B2, and the outer edge 122 moves along the first outer edge trajectory A1B1. The radius of curvature of the first inner edge trajectory A2B2, the radius of curvature of the first outer edge trajectory A1B1, the distance between the first inner edge trajectory A2B2 and the first reference plane X, and the distance between the first outer edge trajectory A1B1 and the second reference plane Y are all specified. The door 12 moves along the trajectories, such that compression applied by the door 12 to the case 11 may be prevented or reduced, and the distance of the door 12 exceeding the side of the case assembly 100 may be prevented or reduced.

Further, in the present embodiment, an end point B2 of the first inner edge trajectory A2B2 is located on the first reference plane X. Alternatively, the end point B2 is located on the side of the first reference plane X away from the opening, and a distance from the end point B2 to the first reference plane X is not greater than 0.058t. An end point B1 of the first outer edge trajectory A1B1 is located on the second reference plane Y. Alternatively, the end point B1 is located on the side of the second reference plane Y facing towards the opening, and the distance from the end point B1 to the second reference plane Y is not greater than 0.135t.

That is, after the door 12 is opened to reach the position having the first opening angle relative to the case 11, the inner edge 121 of the door 12 does not compress the case 11 and does not move excessively away from the case 11; and the outer edge 122 does not exceed the side of the case assembly 100 and does not move to excessively approach the side of the second reference plane Y facing towards the opening. In this way, when opening the door 12, the door 12 may not be significantly displaced, and the movement of the door 12 may be more stable.

In the present embodiment, when the edges of the door 12 move along the first inner edge trajectory A2B2 and the first outer edge trajectory A1B1 to allow the door 12 to be opened to reach a position having 90 degrees relative to the case 11, the door 12 may not be further opened. However, a maximum opening angle of the door body 12 relative to the case 11 is generally required to be greater than 90 degrees. Therefore, after the edges of the door 12 move along the first inner edge trajectory A2B2 and the first outer edge trajectory A1B1 to allow the door 12 to be opened to reach a position having less than 90 degrees relative to the case 11, other movement trajectories may be followed to allow the door 12 to be further opened to reach a position of more than 90 degrees relative to the case 11. In the case where the door 12 is opened for less than 90 degrees relative to the case 11, a length of the first inner edge trajectory A2B2 is greater than a length of the first outer edge trajectory A1B1, and a ratio of the length of the first inner edge trajectory A2B2 to the length of the first outer edge trajectory A1B1 is 3.5 to 4.5.

As described in the above, the door 12 may move along another trajectory after being opened to reach the position having the first opening angle relative to the case 11. In the present embodiment, while the door 12 is opened, under the action of the hinge assembly 13, from the position of the first opening angle relative to the case 11 to a position of a second opening angle relative to the case 11, the inner edge 121 moves along a second inner edge trajectory B2C2 towards the side of the second reference plane Y facing towards the opening and the side of the first reference plane X away from the opening; and the outer edge 122 moves towards the first reference plane X along the second outer edge trajectory B1C1.

The inner edge 121 starts to move towards the side of the second reference plane Y facing towards the opening. Further, a radius of curvature of the second inner edge trajectory B2C2, i.e., the movement trajectory of the inner edge 121, gradually decreases. An end point C2 of the second inner edge trajectory B2C2 is located on the side of the first reference plane X away from the opening, and a distance between the end point C2 and the first reference plane is not less than 0.3t. In this way, more space is available to allow the door 12 to be opened to reach a position of a larger angle relative to the case 11.

In this process, based on the first outer edge trajectory A1B1, the second outer edge trajectory B1C1 has a radius of curvature of not less than 5t, and a distance of the second outer edge trajectory B1C1 exceeding the side of the second reference plane Y away from the opening is not greater than the first predetermined distance d1.

Based on characteristics of the trajectories described above, while the door 12 is being opened from the position of the first opening angle relative to the case 11 to the position of the second opening angle relative to the case 11, and the door 12 does not compress against the case 11 and does not extend excessively far beyond the side of the case assembly.

The door 12 may further be opened, under the action of the hinge assembly 13, from the position of the second opening angle relative to the case 11 to a position of a third opening angle relative to the case 11. In this process, the inner edge 121 moves along a third inner edge trajectory C2D2 towards the side of the first reference plane X away from the opening, and the outer edge 122 moves along a third outer edge trajectory C1D1 towards the side of the second reference plane Y facing towards the opening. The above movement trajectories in the moving direction correspond to a greater opening angle between the door 12 and the case 11.

The third inner edge trajectory C2D2 and the third outer edge trajectory C1D1 are circular arcs that are concentrically with each other. The third inner edge trajectory C2D2 has a radius of curvature of 0.55t-0.67t, and the third outer edge trajectory C1D1 has a radius of curvature of 0.45t-0.55t.

After the edges of the door 12 move along the first inner edge trajectory A2B2 and the first outer edge trajectory A1B1, in order to achieve an even larger opening angle between the door 12 and the case 11, the edges may further move along the third inner edge trajectory C2D2 and the third outer edge trajectory C1D1. In this way, the problem of the door 12 compressing the box 11 and extending beyond the side of the case assembly may be solved.

However, in the case where the hinge assembly 13 is configured based on the first trajectories and the third trajectories, when the door 12 is rotating around the hinge assembly 13, the door 12 may shake while being rotating. For further optimization and solving the problem of shaking, the second trajectories are defined between the first trajectories and the third trajectories, such that the door 12 may move more stably and smoothly.

In addition, considering configuration of the hinge assembly 13, a ratio of the radius of curvature of the third inner edge trajectory C2D2 to the radius of curvature of the third outer edge trajectory C1D1 is 1.22. In this way, a structure the hinge assembly 13 corresponding to the third trajectories may not generate any interference.

Details of the three trajectories are as follows. The first trajectories correspond to the first opening angle of 25 degrees to 31 degrees between the door 12 and the case 11. The second trajectories correspond to the second opening angle of 57 degrees to 60 degrees between the door 12 and the case 11. The third trajectories correspond to the third opening angle of 122 degrees to 132 degrees between the door 12 and the case 11.

The length of the first inner edge trajectory A2B2 is 0.465t, and the length of the first outer edge trajectory A1B1 is 0.115t.

The length of the second outer edge trajectory B1C1 is 0.2285t, and the second inner edge trajectory B2C2 is set to allow the distance of the inner edge 121 moving on the second inner edge trajectory B2C2 and an angle of the door 12 rotating relative to the case 11 to satisfy the following formula:

$$θ 1 = \frac{t 1}{t} θ$$

The θ1 is the rotating angle, the t1 is the moving distance, and the θ is a predetermined angle of 100 degrees-113 degrees.

The radius of curvature of the third inner edge trajectory C2D2 is 0.61t, and the radius of curvature of the third outer edge trajectory C1D1 is 0.5t. A center of the third inner edge trajectory C2D2 and the third outer edge trajectory C1D1 is located inside the door 12. A distance from the center of the third trajectories to the first reference plane X is 0.6t, and a distance from the center of the third trajectories to the second reference plane Y is 0.5t.

In practice, deformation caused by mounting and other issues need to be considered, and therefore, a reference point may be determined, and a trajectory may be designed for the determined reference point. In this way, a tolerance may be reserved for the edges of the door 12, ensuring that the door 12 is prevented from compressing the case 11 and prevented from extending beyond the side of the case assembly 100.

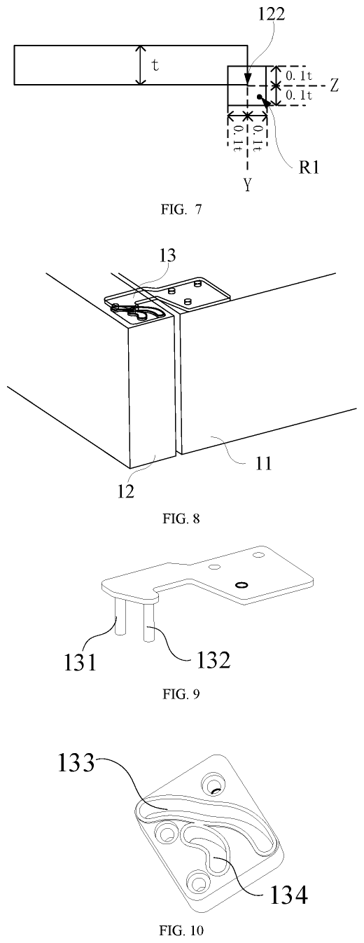

As shown in FIG. 5, FIG. 6, and FIG. 7, FIG. 5 is a schematic view of a movement trajectory of a reference point of the case assembly shown in FIG. 1 in the first embodiment of the present disclosure, FIG. 6 is a schematic view of a value range of an inner reference point of the case assembly shown in FIG. 1 in the first embodiment of the present disclosure, and FIG. 7 is a schematic view of a value range of an outer reference point of the case assembly shown in FIG. 1 in the first embodiment of the present disclosure.

An inner reference point R2 and an outer reference point R1 are arranged in the present embodiment. The inner reference point R2 is adjacent to the inner edge 121, and the outer reference point R1 is adjacent to the outer edge 122.

In detail, a perpendicular distance from the inner reference point R2 to the first reference plane X is not greater than 0.1t, and a perpendicular distance from the inner reference point R2 to the second reference plane Y is not greater than 0.1t. That is, when the door 12 is viewed from the top, the inner reference point R2 may be a point located within a rectangular region, the inner edge 121 is the center of the rectangular region, and a length of each side of the rectangular region is 0.2t. Similarly, a perpendicular distance from the outer reference point R1 to the second reference plane Y is not greater than 0.1t, and a perpendicular distance from the outer reference point R1 to the third reference plane Z is not greater than 0.1t. That is, when the door 12 is viewed from the top, the outer reference point R1 may be a point located within another rectangular region, the outer edge 122 is the center of the another rectangular region, and a length of each side of the another rectangular region is 0.2t.

A point on the inner edge 121 may be determined as the inner reference point R2, and a point on the outer edge 122 may be determined as the outer reference point R1.

A concept of defining trajectories of the inner reference point R2 and the outer reference point R1 may be based on the concept of defining the trajectories of the inner edge 121 and the outer edge 122 as described in the above. When the door 12 is being opened, under the action of hinge assembly 13, from the closed state relative to the case 11 to the position of the first opening angle relative to the case 11, the inner reference point R2 moves, along a first inner reference point trajectory E2F2, towards the side of the second reference plane Y facing towards the opening, and the outer reference point R1 moves, along a first outer reference point trajectory E1F1, towards the first reference plane X.

Features of the first inner reference point trajectory E2F2 may be similar to those of the first inner edge trajectory A2B2. Features of the first outer reference point trajectory E1F1 may be similar to the those of the first outer edge trajectory A1B1. Details of the reference point trajectories will not be repeated herein.

For ease of design, in the present embodiment, each of the first inner reference point trajectory E2F2 and the first outer reference point trajectory E1F1 is a straight line. Based on the location at which the inner reference point R2 is determined, the first inner reference point trajectory E2F2 may be extending along the first reference plane X or parallel to the first reference plane X. Based on the location at which the outer reference point R1 is determined, the first outer reference point trajectory is extending along the second reference plane Y or parallel to the second reference plane Y.

Further, a length of the first inner reference point trajectory E2F2 is greater than a length of the first outer reference point trajectory E1F1, and a ratio of the length of the first inner reference point trajectory E2F2 to the length of the first outer reference point trajectory E1F1 is 3.5 to 4.5.

Similarly, corresponding to the inner edge, the inner reference point R2 may follow the second inner edge trajectory and the third inner edge trajectory; and corresponding to the outer edge, the outer reference point R1 may follow the second outer edge trajectory and the third outer edge trajectory. The second inner reference point trajectory F2G2 may have features similar to the second inner edge trajectory B2C2, and the second outer reference point trajectory F1G1 may have features similar to the second outer edge trajectory B1C1. The third inner reference point trajectory G2H2 may have features similar to the third inner edge trajectory C2D2, and the third outer reference point trajectory G1H1 may have features similar to the third outer edge trajectory C1D1.

When the door body 12 is being opened, under the action of the hinge assembly 13, from the position of the first opening angle relative to the case 11 to the position of the second opening angle relative to the case 11, the inner reference point R2 moves along the second inner reference point trajectory F2G2 towards the side of the second reference plane Y facing towards the opening and the side of the first reference plane X away from the opening, and the outer reference point R1 moves along the second outer reference point trajectory F1G1 towards the first reference plane X.

For design convenience, the second outer reference point trajectory F1G1 may be a straight line and may extend along or parallel to the second reference plane Y. The second inner reference point trajectory F2G2 is set to allow a distance of the outer reference point moving on the second outer reference point trajectory and the angle of the door 12 rotating relative to the case 11 to satisfy the following formula:

$$θ 1 = \frac{t 1}{t} θ$$

The θ1 is the rotation angle, the t1 is the movement distance, and the θ is a predetermined angle of 100 degrees-113 degrees.

Starting from the trajectories of the edges of the door 12, various structures of the hinge assembly may be configured based on the principle of relative motion. For example, as shown in FIG. 8-FIG. 10, FIG. 8 is a structural schematic view of the case assembly according to a second embodiment of the present disclosure, FIG. 9 is a structural schematic view of a hinge shaft of the hinge assembly of the case assembly shown in FIG. 8 in the second embodiment of the present disclosure, and FIG. 10 is a structural schematic view of a hinge slot of the hinge assembly of the case assembly shown in FIG. 8 in the second embodiment of the present disclosure.

Compared the first embodiment shown in FIG. 1, only structures of the hinge assembly are shown in detail in the second embodiment. Therefore, reference numerals in the first embodiment may be applied in the second embodiment. For the hinge assembly 13 of the case assembly 100 in the present embodiment, the movement trajectories of the edge of the door 12 are converted into movement trajectories of two fixed points on the door 12 or the case 11. Further, corresponding mechanical structures are configured based on the movement trajectories of the two fixed points. The hinge assembly 13 includes a first guiding mechanism 135 and a second guiding mechanism 136. The first guiding mechanism 135 is configured to allow a movement trajectory of one of the two fixed points to be achieved, and the second guiding mechanism 136 is configured to allow a movement trajectory of the other one of the two fixed points to be achieved. That is, the two guiding mechanisms cooperate with each other to enable the edges of the door 12 to move along the predetermined trajectories.

In FIG. 8-FIG. 10, the guiding mechanism is a structure of a post being engaged with a slot. Obviously, the guide mechanism configured based on the trajectories may be a structure of a connecting rod, a structure of the slot-post in addition to the connecting rod, and so on.

The hinge assembly 13 in the present embodiment has two shafts and two slots. The two slots are defined in the door 12, and the two shafts are arranged on the case 11. Similarly, in other embodiments, the two slots may be defined in the case 11, and the two shafts are arranged on the door 12. Alternatively, the door 12 may define one of the two shafts and may be arranged with one of the two slots, and the corresponding case 11 may define the other one of the two shafts and may be arranged with the other one of the two slots. Alternatively, as described in the above, the shaft and the slot of the door 12 and the shaft and the slot of the case 11 may be configured into connecting rod structures, or a sliding structure of the shaft and a rack, and so on.

Specifically, in the present embodiment, the hinge assembly 13 includes a first hinge shaft 131 arranged on the case 11, a second hinge shaft 132 arranged on the case 11, a first hinge slot 133 defined in the door 12, and a second hinge slot 134 defined in the door 12. The first hinge shaft 131 moves inside the first hinge slot 133. The first hinge shaft 131 and the first hinge slot 133 serve as the first guiding mechanism 135. The second hinge shaft 132 moves inside the second hinge slot 134. The second hinge shaft 132 and the second hinge slot 134 serve as the second guiding mechanism 136. In this way, the movement trajectories of the edges of the door as shown in FIG. 3 are achieved, and therefore, the problem of the door 12 compressing the box body 11 and exceeding the side of the case assembly 100 is solved.

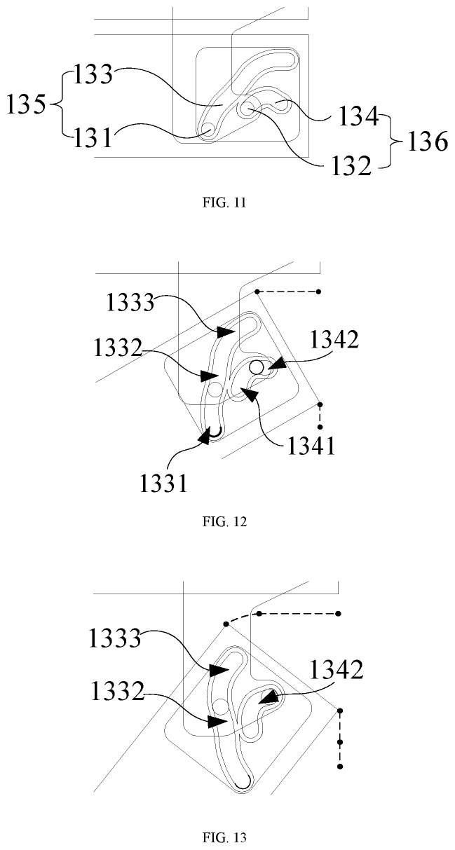

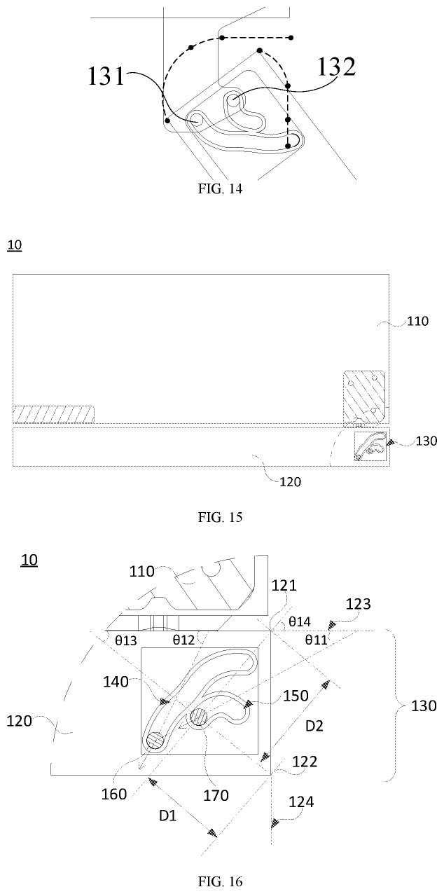

While the door 12 is being opened, moving states of the hinge assembly 13 are shown in FIG. 11 to FIG. 14, FIG. 11 is a schematic view showing a state of the hinge assembly, when the door being in the closed state relative to the case, of the case assembly shown in FIG. 8 in the second embodiment of the present disclosure, FIG. 12 is a schematic view showing a state of the hinge assembly, when the door being opened to the position of the first opening angle relative to the case, of the case assembly shown in FIG. 8 in the second embodiment of the present disclosure, FIG. 13 is a schematic view showing a state of the hinge assembly, when the door being opened to the position of the second opening angle relative to the case, of the case assembly shown in FIG. 8 in the second embodiment of the present disclosure, and FIG. 14 is a schematic view showing a state of the hinge assembly, when the door being opened to the position of the third opening angle relative to the case, of the case assembly shown in FIG. 8 in the second embodiment of the present disclosure.

In the present embodiment, the first hinge slot 133 includes a first slot section 1331, a second slot section 1332, and a third slot section 1333. The second hinge slot 134 includes a fourth slot section 1341 and a fifth slot section 1342.

When the door 12 is opened from the closed state to the position of the first opening angle relative to the case 11, the first hinge shaft 131 moves along the first slot section 1331, and the second hinge shaft 132 moves along the fourth slot section 1341, corresponding to the achievement of the first trajectories in FIG. 3.

When the door 12 is opened from the position of the first opening angle relative to the case 11 to the position of the second opening angle relative to the case 11, the first hinge shaft 131 moves along the second slot section 1332, and the second hinge shaft 132 moves along the fifth slot section 1342, corresponding to the achievement of the second trajectories in FIG. 3.

When the door 12 is opened from the position of the second opening angle relative to the case 11 to the position of the third opening angle relative to the case 11, the first hinge shaft 131 moves along the third slot section 1333, and the second hinge shaft 132 is disposed at a bottom end of the fifth slot section 1342 and is not displaced, corresponding to the achievement of the third trajectories in FIG. 3.

The first hinge slot 133 and the second hinge slot 134 have a tendency of separating away from each other in a direction approaching towards the first reference plane. The first slot section 1331 is disposed at a side of the fourth slot section 1341 away from the second reference plane Y and extends towards the first reference plane X and the second reference plane Y. An angle between a tangent direction of the first slot section 1331 and the first reference plane X is greater than an angle between a tangent direction of the fourth slot section 1341 and the first reference plane X.

The configuration of the hinge assembly 13 in the present embodiment allows the door 12 to be opened stably and smoothly relative to the case 11, does not compress the case 11, and does not extend beyond the side of the case assembly 100. Therefore, the case assembly 11 may be embed into the wall for use.

While the product is being processed in practice, due to manufacturing tolerances, the radius of curvature of a part of the first outer edge trajectory may be less than 5t, and the radius of curvature of a part of the first inner edge trajectory may be less than 100t.

In an embodiment, while the product is being processed in practice, a receiving slot communicated with the first hinge slot 133 may be further defined and may extend from an end of the first hinge slot 133 away from the inner edge. That is, a receiving slot, which is communicated with the first slot section 1331, is defined and extends from an end of the first slot section 1331 away from the second slot section 1332. In this way, when the door 12 is in the closed state, the first hinge shaft 131 is spaced apart from a wall of the end of the first slot section 1331 away from the second slot section 1332.

When the door is being closed abnormally, for example, when the door is being closed by a relatively large closing force, the door, after being normally closed relative to the case, may further compress the case. In this case, the first hinge shaft 131 may further move to be received into the receiving slot, and therefore, the first hinge shaft 131 may not be blocked, vibration of the case assembly may be reduced, and the door may be closed more stably.

When the door is being opened, after being closed abnormally, from the closed state to the position having the first opening angle relative to the case, the first hinge shaft 131 needs to firstly move out of the receiving slot to be received into the first slot section 1331. In this way, the radius of curvature of the first outer edge trajectory may be less than 5t, and the radius of curvature of the first inner edge trajectory may be less than 100t. However, when the door is being closed normally, the first hinge shaft 131 may not be received in the receiving slot.

In an embodiment, while the product is being processed in practice, the receiving slot, which is communicated with the first hinge slot 133, may be defined and may extend from an end of the first hinge slot 133 near the inner edge. That is, the receiving slot, which is communicated with the third slot section 1333, is defined and extends from an end of the third slot section 1333 away from the second slot section 1332. In this way, when the door 12 is in the normal closed state, the first hinge shaft 131 is spaced apart from a wall of the end of the third slot section 1333 away from the second slot section 1332.

When the door is being opened abnormally, for example, when the door is being opened by a relatively large force, the door may move, after being opened relative to the case, further away from the case. In this way, the first hinge shaft 131 may further move to be received in the receiving slot, and therefore, the first hinge shaft 131 may not be blocked, vibration of the case assembly may be reduced, and the door may be closed more stably.

When the door is being opened abnormally from the closed state to the position of the second opening angle relative to the case, the first hinge shaft firstly needs to move out of the receiving slot to be received in the third slot section 1333. In this way, the radius of curvature of the first outer edge trajectory is less than 5t, and the radius of curvature of the first inner edge trajectory is less than 100t. However, when the door is opened normally, the first hinge shaft 131 may not be received in the receiving slot.

In some embodiments, the above configuration may be applied to both ends of the first hinge slot.

In summary, for the present disclosure, different hinge assemblies may be configured for different trajectories of the edges of the door. All of the different hinge assemblies may reduce the problem of the door compressing the case and exceeding the side of the case assembly when the door is being opened. The case assembly as described in the above may be applied to any door which may compress the case and have interference when exceeding the case assembly, such as a refrigerator and so on.

In another embodiment of the present disclosure, a case assembly is provided as shown in FIG. 15 and FIG. 16. In a third embodiment of the present disclosure, the case assembly 10 includes the case 110, the door 120, and the hinge assembly 130. The case 110 defines a receiving space, and the receiving space has an opening. The door 120 is configured to block the opening. The hinge assembly 130 is arranged on a pivot side of the case 110. The hinge assembly 130 is configured to pivotally connect the case 110 to the door 120. That is, the door 120 may be opened or closed relative to the case 11 under the action of the hinge assembly 130. A thickness of the door 120 is greater than or equal to 2 cm.

The door 12 has an inner edge 121 and an outer edge 122 on the pivot side. The case assembly 10 has a first reference plane 123 and a second reference plane 124. The first reference plane 123 passes through, while the door is in the closed state, the inner edge 121 (for example, the inner edge 121 is located on and extending on the first reference plane 123) and is parallel to a plane on which the opening is located. The second reference plane 124 passes through, while the door is in the closed state, the outer edge 122 (for example, the outer edge 122 is located on and extending on the first reference plane 124) and is perpendicular to the plane on which the opening is located. The first reference plane 123 and the second reference plane 124 are staying at rest with respect to the case 110 when the door 120 is being opened relative to the case 110.

The hinge assembly 130 includes an inner slot 140 defined in the door 120, an outer slot 150 defined in the door 120, an inner shaft 160 arranged on the case 110, and an outer shaft 170 arranged on the case 110. The inner slot 140 is disposed on a side of the outer slot 150 away from the second reference plane 124. The outer slot 150 is engaged with the outer shaft 170, such that a shaft center of the outer shaft 170 serves as a first hinge point. The inner slot 140 is engaged with the inner shaft 160, such that a shaft center of the inner shaft 160 serves as a second hinge point. The second hinge point is disposed away from the outer edge 122 with respect to the first hinge point (that is, an orthogonal projection of the first hinge point onto a perpendicular line from the second hinge point to the outer edge 122 lies between the second hinge point and the outer edge 122).

While the door 120 is being opened, under the action of the hinge assembly 130, relative to the case 110, the door 120 moves, at the first hinge point, in a first moving direction relative to the case 110; and the door 120 moves, at the second hinge point, in a second moving direction relative to the case 110. A first angle θ11 is generated between the first moving direction and the first reference plane 123, and a second angle θ12 is generated between the second moving direction and the first reference plane 123. The first angle θ11 and the second angle θ12 are defined as follows. When the first moving direction is set to extend away from the first reference plane, the first angle θ11 is a positive value. When the first moving direction is set to extend away from the second reference plane 124, an absolute value of the first angle θ11 is less than 90 degrees. That is, when the first moving direction is approaching towards the first reference plane, the first angle θ11 is a negative value. When the first moving direction is approaching towards the second reference plane, the absolute value of the first angle θ11 is greater than 90 degrees. When the second moving direction is set extending away from the second reference plane 124, the second angle θ12 is a positive value. When the second moving direction is set to extend away from the second reference plane 124, an absolute value of the second angle θ12 is less than 90 degrees. However, when the second moving direction is approaching towards the second reference plane 124, the second angle is a negative value. When the second moving direction is approaching towards the second reference plane 124, an absolute value of the second angle is greater than 90 degrees.

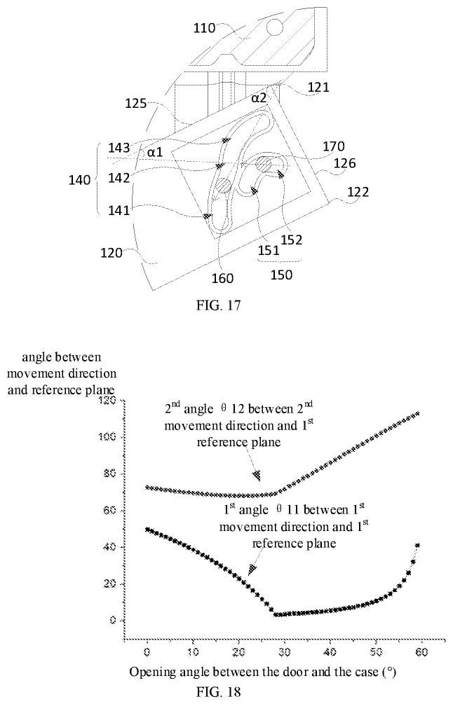

As shown in FIG. 17 and FIG. 18, while the door 120 is being rotated from the closed state relative to the case to the position of the first opening angle relative to the case, the shafts move in the slots along first trajectories. In this process, the second angle θ12 is positive and is less than 90 degrees; the first angle θ11 gradually decreases from a first initial angle, which is positive and less than 90 degrees, to a first termination angle; and a difference between the second angle θ12 and the first angle θ11, corresponding to the same opening angle between the door and the case, is gradually increased as the door 120 is being opened relative to the case 110. From the perspective of the motion relationship, the above motion trends at the two hinge points correspond to motions of the door relative to the case, and the motions include rotation and movement. The movement has a tendency of moving away from the first reference plane and the second reference plane, counteracting a tendency of the door compressing the case and exceeding the side of the case assembly. Therefore, in the present disclosure, the door is prevented from excessively compressing the case or excessively exceeding the side of the case assembly.

Based on the concept of designing the movement at the first hinge point and the second hinge point as described in the above, when the door is desired to be opened to reach a position of a relatively large opening angle relative to the case, the movement trajectories of the first hinge point and the second hinge point may be quite long, and the corresponding slots need to be defined to be larger. In this case, a size of the hinge assembly may be large, and a manufacturing cost may be large. Therefore, the movement trajectories of the hinge points are designed into a plurality of sections. That is, for one of the plurality of sections corresponding to the first opening angle, the movement trajectories of the first hinge point and the second hinge point are designed based on the above designing concepts. That is, while the door is being opened from the closed state relative to the case to the position of the first opening angle relative to the case, the movement trajectories of the first hinge point and the second hinge point are designed based on the above designing concepts. As the opening angle between the door and the case increases, other concepts for designing the movement trajectories of the hinge points are applied. Therefore, in the present embodiment, the first opening angle is set between 25 degrees and 31 degrees, which may be 25 degrees, 27.8 degrees, 28 degrees, 31 degrees, and so on.

Specifically, in the present embodiment, the first angle θ11 is gradually decreased from the first initial angle to the first termination angle, and the difference between the second angle θ12 and the first angle θ11 is gradually increased. As the door is being opened to reach the position of the first opening angle relative to the case, the moving directions of the door at the two hinge points are located at two sides of the 45 degrees. In this way, the hinge point of a small-sized hinge assembly may have a longest trajectory. Therefore, in the present embodiment, the first initial angle of the first angle θ11 is in a range between +55 degrees and +45 degrees, such as +55 degrees, +50 degrees, +45 degrees, and so on; and the first termination angle is in a range between +1 degrees and +11 degrees, such as +1 degrees, +6, +11 degrees, and so on. The second angle θ12 is in a range between +78 degrees and +64 degrees, specifically between 73 degrees and 69 degrees, such as +78 degrees, +71 degrees, +64 degrees, and so on. In the process, the second angle θ12 is firstly decreased from 73 degrees to 69 degrees, and subsequently, increased from 69 degrees to 70 degrees.

Further, in the present embodiment, the inner shaft 160 and the outer shaft 170 are disposed on the case, and the inner slot 140 and the outer slot 150 are defined in the door. The inner shaft 160 serves as the second hinge point, and the outer shaft 170 serves as the first hinge point. The inner shaft 160 is disposed closer to an inner wall surface of the door 120. When the door 120 is rotated to be opened from the closed state to the position of the first opening angle relative to the case, in order to allow the door 120 to move away from the wall surface, obviously, a movement trajectory of the inner shaft 160 is longer than a movement trajectory of the outer shaft 170. In the present embodiment, a ratio of a length of the movement trajectory of the inner shaft 160 moving relative to the inner slot 140 to a length of the movement trajectory of the outer shaft 170 moving relative to the outer slot 150 is in a range of 1.2 to 1.4, such as 1.2, 1.3, 1.31, 1.4, and so on, such that the door 120 may be rotated with respect to the case 110 in the counterclockwise direction shown in FIG. 16.

After the door 120 is opened to reach the position of the first opening angle relative to the case, motions of the first hinge point and the second hinge point may be changed, such that the door may be further opened stably to reach a position of a larger angle relative to the case. As shown in FIG. 17 to FIG. 19, in the process rotating the door 120 from the position of the first opening angle relative to the case to the position of the second opening angle relative to the case, the first angle θ11 gradually increases from a second initial angle to a second termination angle, and an absolute value of the second initial angle is less than 90 degrees; and the second angle θ12 gradually increases from a third initial angle to a third termination angle, the third initial angle is positive and is less than 90 degrees. A difference between the second angle θ12 and the first angle θ11, corresponding to the same opening angle between the door 120 and the case 110, at least gradually increases firstly while the door 120 is being opened from the position of the first opening angle relative to the case to the position of the second opening angle relative to the case.

Similarly, when the door 120 is opened at the first opening angle with respect to the case 110, and as the difference between the second angle θ12 and the first angle θ11 gradually increases, the door 120 has a tendency of moving away from the first reference plane with respect to the case 110, and a distance from the outer shaft 170 to the inner edge 121 and a distance from the outer shaft 170 to the outer edge 122 are gradually decreased. That is, the door 120, with respect to the case 110, has a tendency of moving away from the second reference plane.

While the door 120 is being opened, the distance from the outer shaft 170 to the inner edge 121 and the distance from the outer shaft 170 to the outer edge 122 gradually decrease. From the perspective of mathematics, decreasing the distances counteracts an increase in a projection of a connection line between the outer shaft 170 and the outer edge 122 onto the first reference plane 123 and counteracts an increase in a projection of a connection line between the outer shaft 170 and the inner edge 121 onto the second reference plane 124. Therefore, while the door 120 is being opened, the door 120 may be prevented from exceeding the side of the case assembly and prevented from excessively compressing the case 110.

In the present embodiment, the second opening angle is in a range between 57 degrees and 60, such as 57 degrees, 59 degrees, or 60 degrees. The difference between the second angle θ12 and the first angle θ11, corresponding to the same opening angle between the door 120 and the case 110, is firstly gradually increased and subsequently gradually decreased. While the difference is transitioning from being gradually increased to being gradually decreased, the corresponding opening angle between the door 120 and the case 110 is in a range between 50 degrees and 60 degrees, such as 50 degrees, 55 degrees, 60 degrees, and so on.

By analyzing the movement trajectories, when the opening angle between the door 120 and the case 110 is 45 degrees, the compression applied by the door 120 to the case 110 may be larger, and the distance that the door exceeds the side of the case assembly may be larger. Therefore, when the door is opened from the closed state to the position of 45 degrees relative to the case, the door 120, relative to the case 110, needs to have the tendency of moving away from the first reference plane and the second reference plane. Therefore, in this process, the difference between the second angle θ12 and the first angle θ11 is gradually increased. When the door 120 is further opened to have a larger opening angle relative to the case, and when the door 120 further moves away from the first reference plane and the second reference plane, the door 120 may be excessively far away from the case 110, resulting in the door 120 to be unstable. Therefore, when the opening angle between the door and the case is greater than 45 degrees, the door 120 shall not move further away from the first reference plane and the second reference plane, and the door 120 shall not move further away from the case 110. Therefore, the difference between the second angle θ12 and the first angle θ11 is set to be gradually increased and subsequently gradually decreased.

Furthermore, after the opening angle between the door and the case is greater than 45 degrees, the situation of the difference between the second angle θ12 and the first angle θ11 being gradually decreased may be a theoretical situation. Considering smoothness of the hinges when the door 120 is being opened, while the difference is transitioning from being gradually increased to being gradually decreased, the corresponding opening angle between the door 120 and the case 110 is in the range between 50 degrees and 60 degrees, such as 50 degrees, degrees, 60 degrees, and so on.

Corresponding to the door 120 being further opened relative to the case, motion tendencies of the hinge points are continuation of (i.e., the same as) the motion tendencies of the hinge points while the door is being opened from the closed state to the position of the first opening angle relative to the case. The first angle θ11 is gradually increased from the second initial angle to the second termination angle. The second initial angle is in a range between +1 degree and +11 degrees, such as +1 degree, +6 degrees, +11 degrees, and so on. The second termination angle is in a range between +36 degrees and +46 degrees, such as +36 degrees, +41 degrees, +46 degrees, and so on. The second pinch angle θ12 is gradually increased from the third initial angle to the third termination angle. The third initial angle is in a range between +65 degrees and +75 degrees, such as +65 degrees, +70 degrees, +75 degrees, and so on. The third termination angle is in a range between +108 degrees and +118 degrees, such as +118 degrees, +123 degrees, +118 degrees, and so on. As the door 120 is opened from the position of the first opening angle relative to the case to the position of the second opening angle relative to the case, as the opening angle increases, the length of the movement trajectory of the inner shaft 160 moving in the inner slot 140 is further longer than the length of the movement trajectory of the outer shaft 170 moving in the outer slot 150. The ratio of the length of the movement trajectory of the inner shaft 160 moving in the inner slot 140 to the length of the movement trajectory of the outer shaft 170 moving in the outer slot 150 is in a range between 2.1 to 2.3, such as 2.1, 2.16, 2.2, 2.3 and so on, such that the door 120 is enabled to rotate relative to the case 110 in the counterclockwise direction as shown in FIG. 16.

While designing the hinge assembly of the present embodiment, the shafts and the slots are designed. In order to ensure stability of the structure, the slots may not be excessively near the edge of the door or the edge of the case. Therefore, in the present embodiment, for each shaft, the distance between the center of the shaft and each reference plane is further limited. When the thickness of the door 120 (i.e., a length of the door 120 in a direction parallel to the second reference plane 124) is t, while the door 120 is being opened, under the action of the hinge assembly 130, from the closed state to a position of a maximum opening angle with respect to the case 110, the distance between the center of the inner shaft 160 and the first reference plane 123 is in a range between 0.75t and 0.77t, such as 0.75t, 0.76t, 0.77t, and so on. The distance from the center of the inner shaft 160 to the second reference plane 124 is in a range between 0.79t and 0.81t, such as 0.79t, 0.80t, 0.81t, and so on. The distance from the outer shaft 170 to the first reference plane 123 is in a range between 0.59t and 0.61t, such as 0.59t, 0.61t, and so on. The distance from the outer shaft 170 to the second reference plane 124 is in a range between 0.49t and 0.51t, such as 0.49t, 0.50t, 0.51t, and so on.

When the door is being opened from the position of the first opening angle relative to the case to the position of the second opening angle relative to the case, the first angle θ11 gradually increases from the second initial angle to the second termination angle, and the absolute value of the second initial angle is less than 90 degrees; and the second angle θ12 gradually increases from the third initial angle to the third termination angle, the third initial angle is positive and less than 90 degrees. The difference between the second angle θ12 and the first angle θ11, corresponding to the same opening angle between the door and the case, is at least first gradually increased at first, while the door is being opened from the position of the first opening angle relative to the case to the position of the second opening angle relative to the case.

Corresponding to the tendency of the difference between the second angle θ12 and the first angle θ11 being gradually increased, the door 120, with respect to the case 110, has the tendency of moving away from the first reference plane and the second reference plane. Therefore, the door may not excessively compress the case or exceed the side of the case assembly. Therefore, for the design of the movement of the hinge points, the first opening angle may be a door closing angle, and the second opening angle may be any angle. That is, in the process of the door being opened from the closed state, the design of the hinge points, during the process of the door being opened from the position of the first opening angle relative to the case to position of the second opening angle relative to the case as described above, may be applied directly.

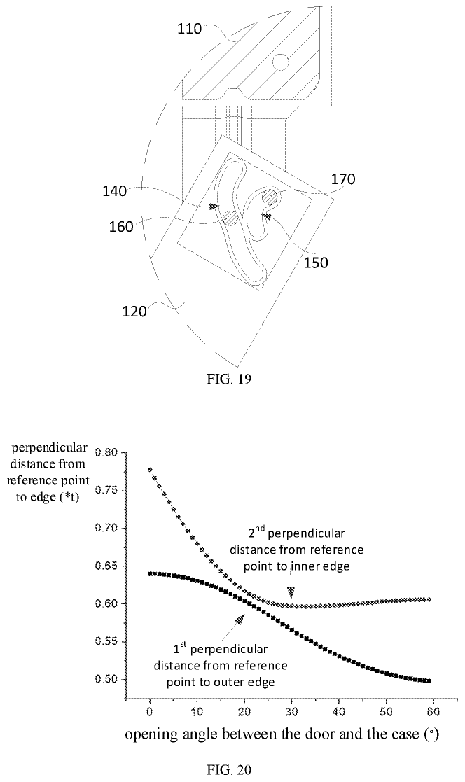

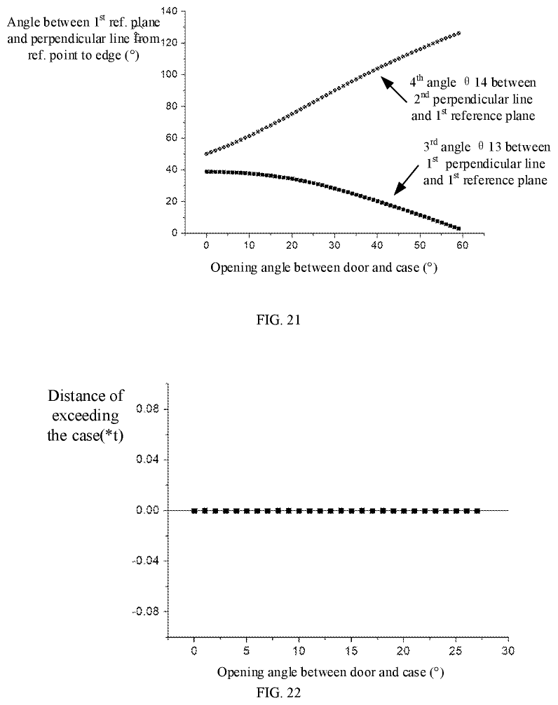

As shown in FIG. 16, FIG. 17, FIG. 19, and FIG. 21, the hinge assembly of the present embodiment may be defined from another perspective. While the door 120 is being opened, under the action of the hinge assembly 130, from the closed state to the position of the maximum opening angle with respect to the case 110, the first hinge point moves from a starting position to an end position, and a reference point of the door 120 is further determined. The reference point coincides with the first hinge point and stays at rest with respect to the case 110 while the door 120 is being opened. The reference point has a first perpendicular line to the outer edge 122 and has a first perpendicular distance D1 to the outer edge 122 along the first perpendicular line. The reference point has a second perpendicular line to the inner edge 121 and has a second perpendicular distance D2 to the inner edge 121 along the second perpendicular line. A third angle θ13 is generated between the first perpendicular line and the first reference plane 123, and a fourth angle θ14 is generated between the second perpendicular line and the first reference plane 123.

As shown in FIG. 16, FIG. 17, FIG. 20, and FIG. 21, in the present embodiment, while rotating the door 120 from the closed state to the position of the first opening angle relative to the case, the first perpendicular distance D1 and the second perpendicular distance D2 are gradually decreased, the third angle θ13 is gradually decreased in a range of 0 degrees to 90 degrees, and the fourth angle θ14 is gradually increased in a range of 0 degrees to degrees.

From the perspective of the movement trajectories, while the door 120 is being opened, the reference point is not displaced, and the third angle θ13 is decreased. Therefore, the outer edge 122 has the tendency of moving towards the first reference plane, corresponding to the process of opening the door, the first perpendicular distance D1 is decreased. Therefore, the outer edge 122 does not move excessively far away from the side of the second reference plane away from the opening, and that is, the door 120 does not excessively extend beyond the side of the case assembly.

Similarly, the fourth angle θ14 is increased. That is, the inner edge 121 has the tendency of moving from away from the second reference plane, corresponding to the process of opening the door. The second perpendicular distance D2 is decreased, and therefore, the inner edge 121 does not move excessively towards the opening, and that is, the door 120 does not excessively compress the case 110.

In addition, from the perspective of mathematics, the distance between the reference point and the second reference plane 124 is D1*cos θ13. As D1 decreases, cos θ13 increases. The D1 and the cos θ13 are negatively correlated, such that the distance of the door 120 exceeding the side (i.e., the second reference plane 124) of the case 110 is decreased while the door 120 is being opened. In addition, since the distance between the reference point and the first reference plane 123 is D2*sin θ14, the sin θ14 increases as the D2 decreases. The D2 and the sin θ14 are negatively correlated, such that the distance of the door 120 compressing the case 110 is decreased while the door 120 is being opened.

In the present embodiment, the reference point corresponds to the first hinge point. In order to optimize the positions at which the first hinge point and the second hinge point are located, the first hinge point is set closer to the second reference plane. In this way, corresponding to the same opening angle between the door 120 and the case 110, the first perpendicular distance D1 is smaller than the second perpendicular distance D2, and the third angle θ13 is smaller than the fourth angle θ14.

In the process of opening the door, based on the moving direction of the outer edge 122 in the present embodiment, a change in the movement of the outer edge 122 is increasing. Therefore, while opening of the door 120, as the angle between the door body 120 and the box 110 increases by each unit of angle, a change in the first perpendicular distance D1 gradually increases, and a change in the movement of the inner edge 121 is decreasing. Therefore, while opening of the door 120, as the angle between the door body 120 and the box 110 increases by each unit of angle, a change in the second perpendicular distance D2 gradually decreases.

Specifically, while designing the hinge assembly of the present embodiment, the shafts and the slots are designed. In order to ensure stability of the structure, the slot may not be disposed excessively near the edge of the door or the edge of the case. Therefore, the first perpendicular distance D1 is gradually decreased from a range between 0.63t and 0.65t (such as 0.63t, 0.64t, 0.65t, and so on) to the range between 0.57t and 0.59t (such as 0.57t, 0.58t, and so on). The second perpendicular distance D2 is gradually decreased from a range between 0.78t and 0.80t (such as 0.78t, 0.79t, 0.80t, and so on) to a range between 0.59t and (such as 0.59t, 0.60t, 0.61t, and so on).

In the present embodiment, the third angle θ13 gradually decreases from a range between 39 degrees and 41 degrees (such as 39 degrees, 40 degrees, 41 degrees, and so on) to a range between 35 degrees and 37 degrees (such as 35 degrees, 36 degrees, 37 degrees, and so on). The fourth angle θ14 gradually increases from a range between 49 degrees and 51 degrees (such as 49 degrees, 50 degrees, 51 degrees, and so on) to a range between 79 degrees and 81 degrees (such as 79 degrees, 80 degrees, 81 degrees, and so on).

As shown in FIG. 22, in the present embodiment, a first product is obtained by multiplying the first perpendicular distance D1 by a cosine value of the third angle θ13. When the door 120 is in the closed state, a first initial product is obtained by multiplying the cosine value of the first perpendicular distance D1 by the third angle θ13. The distance of exceeding the case shown in FIG. 20 is a difference between the first product and the first initial product. When the door 120 rotates from the closed state to the position of the first opening angle relative to the case 110, a difference between a maximum value of the first product and a minimum value of the first product is less than 0.1t, such as 0.1t, 0.05t, 0.02t, and so on, such that the door 120 may be opened with respect to the case 110 more stably, and the first product is constant or gradually decreased to prevent the door 120 from exceeding the side of the case 110 while the door is being opened with respect to the case 110.

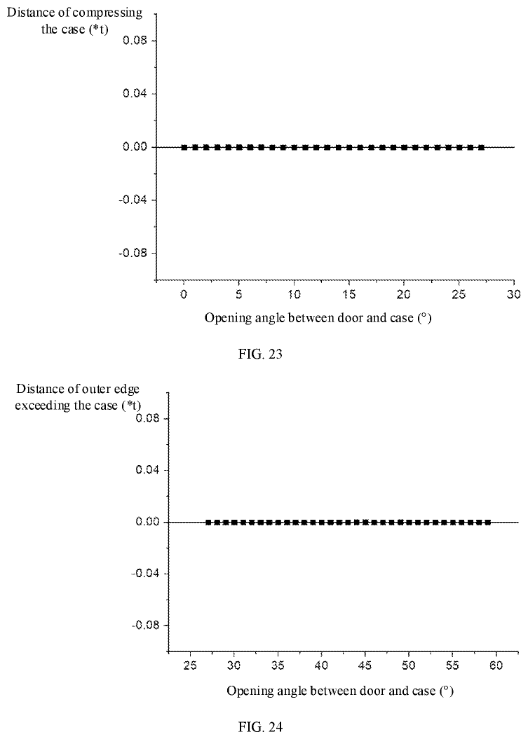

As shown in FIG. 23, in the present embodiment, a second product is obtained by multiplying the second perpendicular distance D2 by a sine value of the fourth angle θ14, and a second initial product is obtained by multiplying the second perpendicular distance D2 by the sine value of the fourth angle θ14 when the door 120 is in the closed state. The distance of the door compressing the case as shown in FIG. 23 is a difference between the second product and the second initial product. When the door 120 is rotated from the closed state to the position of the first opening angle relative to the case 110, a difference between a maximum value of the second product and a minimum value of the second product is less than 0.1t, such as 0.05t, 0.02t, and so on. In this way, the door 120 may be opened with respect to the case 110 more stably, and the second product is constant or is gradually decreased, such that the door 120 does not excessively compress the case 110 while the door 120 is being opened with respect to the case 110.

As shown in FIG. 17, FIG. 19, and FIG. 21, in the present embodiment, while the door 120 is being opened from the position of the first opening angle relative to the case to the position of the second opening angle relative to the case 110, following situations are met. The first perpendicular distance D1 gradually decreases. The third angle θ13 gradually decreases within a range between 0 degrees and 90 degrees. The fourth angle θ14 gradually increases and exceeds 90 degrees, when the opening angle between the door and the case is within a predetermined range and before the second opening angle between the door and the case is reached. The second perpendicular distance D2 gradually increases when the opening angle between the door and the case is within the predetermined range. Similarly, since the distance between the reference point and the second reference plane 124 is D1*cos θ13, the D1 decreases as the cos θ13 increases. The D1 and the cos θ13 are negatively correlated with each other, enabling the distance of the door 120 exceeding the side of the case 110 (i.e., the second reference plane 124) to be decreased. In addition, since the distance between the reference point and the first reference plane 123 is D2*sin θ14, the D2 increases as the sin θ14 decreases when the opening angle between the door and the case is within the predetermined range. The D2 and the sin θ14 are negatively correlated with each other, enabling the distance of the door 120 compressing the case 110, in the process of opening the door, to be decreased.

Based on both the process of opening the door from the closed state to the position of the first opening angle relative to the case, and the process of opening the door from the position of the first opening angle relative to the case to the position of the second opening angle relative to the case, it is known that, based on the concept of defining trajectories for opening the door from the position of the first opening angle relative to the case to the position of the second opening angle relative to the case, the problem of the case being excessively compressed and the side of the case assembly being excessively exceeded may be solved. Therefore, the above designing concept may be applied to the process of opening the door from the closed state to the position of the first opening angle relative to the case, and that is, the first opening angle between the door and the case may be considered as corresponding to the closed state of the door, and the second opening angle between the door and the case may be considered as any arbitrary angle.

In the present embodiment, the fourth angle θ14 is gradually increased from less than 90 degrees to greater than 90 degrees, and the second perpendicular distance D2 is first gradually decreased and subsequently gradually increased, such that the outer shaft 170 may move smoothly relative to the outer slot 150, and the door 120 may be rotated more stably.

In the present embodiment, the first perpendicular distance D1 is gradually decreased from a range between 0.57t and 0.59t (such as 0.57t, 0.58t, 0.59t, and so on) to a range between 0.50t and 0.52t (such as 0.50t, 0.51t, 0.52t, and so on). The second perpendicular distance D2 is gradually increased within a range between 0.59t and 0.61t (such as 0.59t, 0.60t, 0.61t, and so on).

In the present embodiment, as the opening angle between the door 120 and the case 110 increases, the third angle θ13 gradually decreases from a range between 35 degrees and 37 degrees to a range between 2 degrees and 4 degrees, and the fourth angle θ14 gradually increases from a range between 79 degrees and 81 degrees to a range between 125 degrees and 127 degrees.

As shown in FIG. 24, in the present embodiment, a first product is obtained by multiplying the first perpendicular distance D1 by the cosine value of the third angle θ13, and a first initial product is obtained by multiplying the first perpendicular distance D1 by the cosine value of the third angle θ13 when the door 120 is in the closed state. The distance of exceeding the side of the case shown in FIG. 24 is a difference between the first product and the first initial product. In the process of opening the door 120 from the position of the first opening angle relative to the case 110 to the position of the second opening angle relative to the case 110, a difference between a maximum value of the first product and a minimum value of the first product is less than 0.1t, such as 0.1t, 0.05t, 0.02t, and so on. In this way, the door 120 may be opened relative to the case 110 more stably, and the first product is constant or gradually decreased, and therefore, the door 120 does not exceed the side of the case 110 while being opened relative to the case 110.

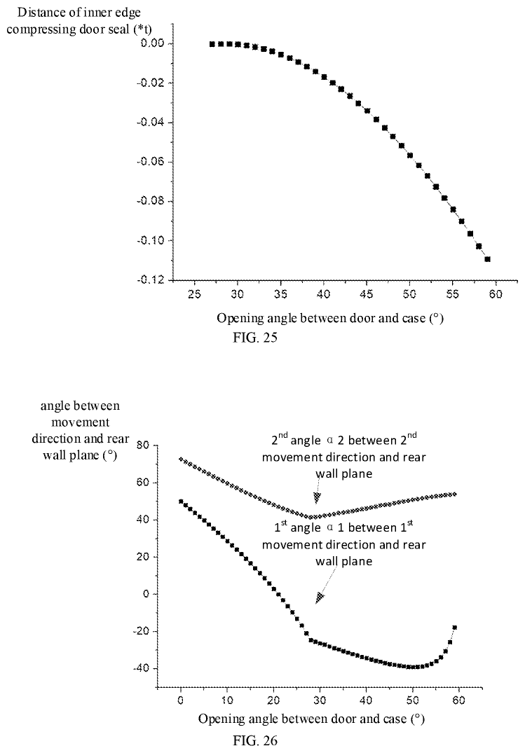

As shown in FIG. 25, in the present embodiment, a second product is obtained by multiplying the second perpendicular distance D2 by the sine value of the fourth angle θ14, and a second initial product is obtained by multiplying the second perpendicular distance D2 by the sine value of the fourth angle θ14 when the door 120 is in the closed state. The distance of compressing the case as shown in FIG. 25 is a difference between the second product and the second initial product. In the process of opening the door 120 from the position of the first opening angle relative to the case 110 to the position of the second opening angle relative to the case 110, the second product is gradually decreased at least when the opening angle between the door and the case is within the predetermined range.

In the present embodiment, a difference between the second product, when the door 120 is at the position of the second opening angle relative to the case, and the second product, when the door 120 is at the position of the first opening angle relative to the case, is not greater than −0.1t, such as −0.1t, −0.05t, −0.02t, and so on. In this way, the door 120 may be opened with respect to the case 110 more stably, and while the door 120 is rotated to be opened, the door. 120 does not excessively compress the case 110.

In the present embodiment, as the angle between the door body 120 and the box 110 increases by each unit of angle, a change in the second product gradually increases.

In addition, for the hinge assembly in the present disclosure, slots and shafts are arranged. Shapes of the slots determine the motion state of the door relative to the case. Apparently, besides the above-mentioned problem of the door excessively compressing the case and excessively exceeding the side of the case assembly needs to be solved, the problem of the movement between the door and the case being jammed may also need to be solved.

As shown in FIG. 15 to FIG. 17, the hinge of the present embodiment may be configured from another perspective. The door 120 further has a rear wall plane 125 and a side wall plane 126. A front wall plane (not shown in the drawings) in the present disclosure is defined as a plane that passes through the outer edge 122 and is parallel to the plane in which the opening is located, when the door 120 is in the closed state relative to the case 110. In this case, the plane passing through the outer edge 122 refers to the outer edge 122 being located on and extending along the plane. The rear wall plane 125 is defined as a plane that passes through the inner edge 121 and is parallel to the plane in which the opening is located, when the door 120 is in the closed state relative to the case 110. In this case, the rear wall plane passing through the inner edge 121 refers to the inner edge 121 being located on and extending along the rear wall plane. The side wall plane 126 is defined as a plane that passes through the outer edge 122 and is perpendicular to the plane in which the opening is located, when the door 120 is in the closed state relative to the case 110. The rear wall plane 125 and the side wall plane 126 move in synchronization as the door 120 moves, while the door 120 is being opened. The thickness t of the door is a spacing distance between the front wall plane and the back wall plane 125.

In the present embodiment, the inner slot 140 has a first inner slot section 141, and the outer slot 150 has a first outer slot section 151. A termination position of the first inner slot section 141 is located, compared to a starting position of the first inner slot section 141, closer to the rear wall plane 125 and the side wall plane 126. A termination position of the first outer slot section 151 is located, compared to a starting position of the first outer slot section 151, closer to the rear wall plane 125 and the side wall plane 126. When the door 120 is rotated to be opened, under the action of the hinge assembly 130, from the closed state to the position of the first opening angle with respect to the case 110, the outer shaft 170 moves, with respect to the outer slot 150, from the starting position of the first outer slot section 151 to the termination position of the first outer slot section 151. Further, the inner shaft 160 moves synchronously, with respect to the inner slot 140, from the starting position of the first inner slot section 141 to the first termination position of the inner slot section 141. In the process of the door 120 being opened from the closed state to the position of the first opening angle relative to the case 110, a second moving direction is always inclined relative to a first moving direction. When the two moving directions are parallel to each other, the movement of the door may be jammed. In the present embodiment, the two moving directions are always inclined with each other, and therefore, the problem of the movement of the door being jammed may be solved.

As shown in FIG. 26, in the present embodiment, a first angle α1 is generated between the first movement direction and the rear wall plane 125, and a second angle α2 is generated between the second movement direction and the rear wall plane 125. Corresponding to the same opening angle between the door 120 and the case 110, the second angle α2 is greater than the first angle α1. In the process of rotating and opening the door 120 from the closed state to the position of the first opening angle relative to the case, each of the first angle α1 and the second angle α2 is gradually decreased, and a difference between the second angle α2 and the first angle α1 is gradually increased. In this way, a distance from the outer shaft 170 to the inner edge 121 and a distance from the outer shaft 170 to the outer edge 122 are decreased. Similar to the above description, this configuration prevents the door 120 from exceeding the side of the case 110 (i.e., the plane in which the side wall plane 126 is located when the door 120 is in the closed state relative to the case) and prevents the door 120 from excessively compressing the case 110, while the door is being opened.

In the present embodiment, the first outer slot section 151 further includes a transition position located between the starting position of the first outer slot section 151 and the termination position of the first outer slot section 151. The transition position of the first outer slot section 151 is located, compared to the starting position of the first outer slot section 151, closer to the rear wall plane 125 and the side wall plane 126. The termination position of the first outer slot section 151 is located, compared to the transition position of the first outer slot section 151, closer to the side wall plane 126 and further away from the rear wall plane 125. The second angle α2 is expressed as a positive value. When the first movement direction is extending away from the rear wall plane 125, the first angle α1 is expressed as a positive value. When the first movement direction is extending towards the rear wall plane 125, the first angle α1 is expressed as a negative value.

In the present embodiment, the first angle α1 gradually decreases from a range between +45 degrees and +55 degrees (such as +45 degrees, +50 degrees, +55 degrees, and so on) to a range between −16 degrees and −26 degrees (such as −16 degrees, −21 degrees, −26 degrees, and so on). The second angle α2 gradually decreases from a range between +68 degrees and +78 degrees (such as +68 degrees, +73 degrees, +78 degrees, and so on) to a range between +37 degrees and +47 degrees (such as +37 degrees, +42 degrees, +47 degrees, and so on).

In the present embodiment, a difference between the second angle α2 and the first angle α1 gradually increases from a range between +13 degrees and +23 degrees (such as +13 degrees, +18 degrees, +23 degrees, and so on) to a range between +63 degrees and +73 degrees (such as +63 degrees, +68 degrees, +73 degrees, and so on).

In the present embodiment, a ratio of a length of the trajectory of the inner shaft 160 moving along the first inner slot section 141 to a length of the trajectory of the outer shaft 170 moving along the first outer slot section 151 is in a range between 1.2 and 1.4, such as 1.2, 1.3, 1.4, and so on. In this way, the door 120 is enabled to rotate in the counterclockwise direction with respect to the case 110 as shown in FIG. 24.

In the present embodiment, the inner slot 140 includes a second inner slot section 142 connected to the first inner slot section 141. The outer slot 150 includes a second outer slot section 152 connected to the first outer slot section 151. A termination position of the second inner slot section 142 is disposed, compared to a starting position of the second inner slot section 142, closer to the rear wall plane 125 and the sidewall plane 126. A termination position of the second outer slot section 152 is disposed, compared to a starting position of the second outer slot section 152, closer to the side wall plane 126 and further away from the rear wall plane 125.

While the door 120 is rotated, under the action of the hinge assembly 130, from the position of the first opening angle relative to the case to the position of the second opening angle relative to the case, the outer shaft 170 moves relative to the outer slot 150. A starting point of the movement of the outer shaft 170 is the starting position of the second outer slot section 152, and an end point of the movement of the outer shaft 170 is the termination position of the second outer slot section 152. The inner shaft 160 moves, synchronously as outer shaft 170 moves, relative to the inner slot 140. A starting point of the movement of the inner shaft 160 is the starting position of the second inner slot section 142, and an end point of the movement of the inner shaft 160 is the termination position of the second inner slot section 142. When the door 120 is rotated from the position of the first opening angle relative to the case to the position of the second opening angle relative to the case 110, the second angle α2 gradually increases, the first angle α1 gradually decreases and subsequently gradually increases, and a difference between the second angle α2 and the first angle α1 gradually increases and subsequently gradually decreases. In this way, the distance from the outer shaft 170 to the inner edge 121 and the distance from the outer shaft 170 to the outer edge 122 are decreased to counteract an increase in a projection of a connection line between the outer shaft 170 and the outer edge 122 onto the first reference plane 123 and counteract an increase in a distance between the outer shaft 170 and the first reference plane 123. In this way, the door 120 is prevented from excessively exceeding the side of the case 110 and from excessively compressing the case 110, while the door is being opened.

In the present embodiment, a ratio of a length of the trajectory of the inner shaft 160 moving along the second inner slot section 142 to a length of the trajectory of the outer shaft 170 moving along the second outer slot section 152 is in a range of 2.1 to 2.3, such as 2.1, 2.2, 2.3, and so on. Therefore, the door 120 is enabled to be rotated relative to the case 110 in the counterclockwise direction, as shown in FIG. 24.

In the present embodiment, while the door 120 is rotated from the position of the first opening angle relative to the case 110 to the position of the second opening angle relative to the case 110, a sum of the first angle α1 and the opening angle, corresponding to the first angle α1, between the door body 120 and the case 110 is gradually increased.

In the present embodiment, the second angle α2 gradually increases from a range of +37 degrees to +47 degrees (such as +37 degrees, +42 degrees, +47 degrees, and so on) to a range of +49 degrees to +59 degrees (such as +49 degrees, +54 degrees, +59 degrees, and so on). The first angle α1 gradually firstly decreases from a range of −16 degrees to −26 degrees (such as −16 degrees, −21 degrees, −26 degrees, and so on) to a range of −34 to −44 degrees (such as −34 degrees, −39 degrees, −44 degrees, and so on), and subsequently gradually increases to a range of −13 to −23 degrees (such as −13 degrees, −18 degrees, −23 degrees, and so on).

In the present embodiment, a difference between the second angle α2 and the first angle α1 is firstly gradually increased from a range between +58 degrees and +68 degrees (such as +58 degrees, +63 degrees, +68 degrees, and so on) to a range between +85 degrees and +95 degrees (such as +85 degrees, +90 degrees, +95 degrees, and so on), and subsequently gradually decreased to a range between +67 degrees and +77 degrees (such as +67 degrees, +72 degrees, +77 degrees, and so on). A change in the difference, while the difference being gradually increased and as the angle between the door body 120 and the box 110 being increased by each unit of angle, between the second angle α2 and the first angle α1 is greater than a change in the difference, while the difference being gradually decreased and as the angle between the door body 120 and the box 110 being increased by each unit of angle, between the second angle α2 and the first angle α1.

In the present embodiment, corresponding to the difference between the second angle α2 and the first angle α1 being transitioned to the gradual increasing, the opening angle between the door 120 and the case 110 is in a range of between 50 degrees and 60 degrees, such as 50 degrees, 55 degrees, 60 degrees, and so on.

In the present embodiment, when the door 120 is in the closed state, a distance from the center of the inner shaft 160 to the rear wall plane 125 is in a range between and 0.77t, such as 0.75t, 0.76t, 0.77t, and so on; a distance from the center of the inner shaft 160 to the side wall plane 126 is in a range between 0.79t and 0.81t, such as 0.79t, 0.80t, and so on; a distance from the center of the outer shaft 170 to the rear wall plane 125 is in a range between 0.59t and 0.61t, such as 0.59t, 0.60t, 0.61t, and so on; and a distance from the center of the outer shaft 170 to the side wall plane 126 is in a range between 0.49t and 0.51t, such as 0.49t, 0.50t, 0.51t, and so on.

When the opening angle between the door 120 and the case 110 is the first opening angle, a distance from the center of the inner shaft 160 to the rear wall plane 125 is in a range between 0.51t and 0.53t, such as 0.51t, 0.52t, 0.53t, and so on; a distance from the center of the inner shaft 160 to the side wall plane 126 is in a range between 0.64t and 0.66t, such as 0.64t, 0.65t, 0.66t, and so on; a distance from the center of the outer shaft 170 to the rear wall plane 125 is in a range between 0.50t and 0.52t, such as 0.50t, 0.51t, 0.52t, and so on; and a distance from the center of the outer shaft 170 to the side wall plane 126 is in a range between and 0.32t, such as 0.30t, 0.31t, 0.32t, and so on.

When the opening angle between the door 120 and the case 110 is the second opening angle, a distance from the center of the inner shaft 160 to the rear wall plane 125 is in a range between 0.37t and 0.39t, such as 0.37t, 0.38t, 0.39t, and so on; a distance from the center of the inner shaft 160 to the side wall plane 126 is in a range between 0.52t and 0.54t, such as 0.52t, 0.53t, 0.54t, and so on; a distance from the center of the outer shaft 170 to the rear wall plane 125 is in a range between 0.55t and 0.57t, such as 0.55t, 0.56t, 0.57t, and so on; and a distance from the center of the outer shaft 170 to the side wall plane 126 is in a range between and 0.24t, such as 0.22t, 0.23t, 0.24t, and so on.

In the present embodiment, the inner slot 140 includes a third inner slot section 143 connected to the second inner slot section 142. The third inner slot section 143 is a circular arc, taking the termination position of the second outer slot section 152 as a center. When the door 120 is being opened, under the action of the hinge assembly 120, from the position of the second opening angle relative to the case 110 to the position of the third opening angle relative to the case 110, the outer shaft 170 rotates relative to the termination position of the second outer slot section 152 of the second outer slot 150, and synchronously, the inner shaft 160 moves, relative to the inner slot 140, from the starting position of the third inner slot section 143 to the termination position of the third inner slot section 143.

In the present embodiment, the third opening angle is in a range between 122 degrees and 132 degrees, such as 122 degrees, 127 degrees, 132 degrees, and so on.

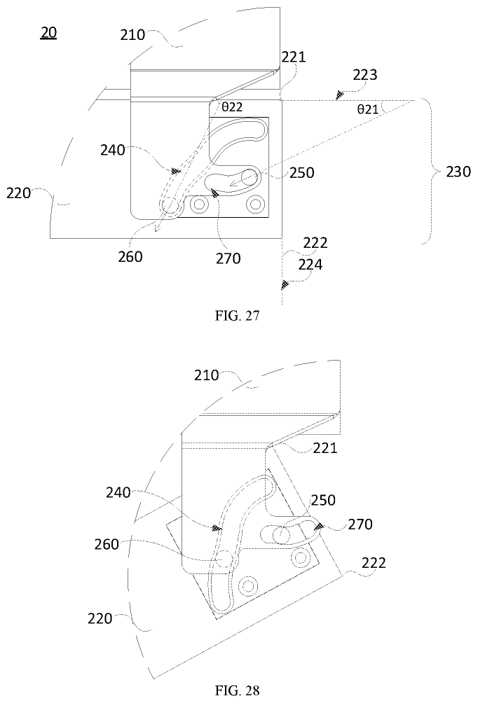

As shown in FIG. 27, in a fourth embodiment, the case assembly 20 includes a case 210, a door 220, and a hinge assembly 230. The case 210 defines a receiving space, and the receiving space has an opening. The door 220 covers the opening to block the opening. The hinge assembly 230 is disposed at a pivot side of the case 210. The hinge assembly 230 is configured to pivotally connect the case 210 with the door 220. Definitions of the inner edge 221, the outer edge 222, the first reference plane 223, and the second reference plane 224 may be referred to the definitions of the case assembly 10 in the third embodiment of the present disclosure, and will not be repeated herein.

Differences between the present embedment and the above embodiments are as follows. In the present embodiment, the inner slot 240 and the outer shaft 250 of the hinge assembly 230 are located on the door 220, and the inner shaft 260 and the outer slot 270 of the hinge assembly 230 are located on the case 210. The outer slot 270 is engaged with the outer shaft 250, such that a shaft center of the outer shaft 250 serves as the first hinge point. The inner slot 240 is engaged with the inner shaft 260, such that a shaft center of the inner shaft 260 serves as the second hinge point. The second hinge point is disposed, compared to the first hinge point, away from the outer edge 222. Obviously, configuration of the hinge point in the present embodiment is the same as that in the above embodiment.

When the door 220 is being opened, under the action of the hinge assembly 230, relative to the case 210, the door 220 moves along a first movement direction relative to the case 210 at the first hinge point and moves along a second movement direction relative to the case 210 at the second hinge point. A first angle θ21 is generated between the first movement direction and the first reference plane 223. A second angle θ22 is generated between the second movement direction and the first reference plane 223. Definitions of the first angle θ21 and the second angle θ22 are referred to the definitions in the above-described third embodiment of the case assembly 10, and will not be repeated herein.

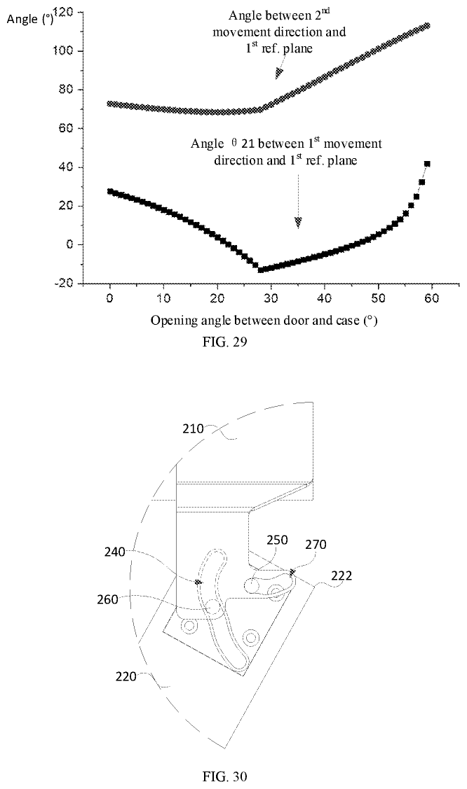

As shown in FIG. 28 and FIG. 29, in the process of rotating the door 220 from the closed state to the position of the first opening angle relative to the case, the second angle θ22 is positive and less than 90 degrees; the first angle θ21 gradually decreases from a first initial angle, which is positive and less than 90 degrees, to a first termination angle; and a difference between the second angle θ22 and the first angle θ21, corresponding to the same opening angle between the door 220 and the case 210, gradually increases. From the perspective of motion relationships, the above motion trends at the two hinge points correspond to motions of the door relative to the case, and the motions include rotation and movement. The movement has a tendency of moving away from the first reference plane and the second reference plane, counteracting a tendency of the door compressing the case and exceeding the side of the case assembly. Therefore, in the present disclosure, the door is prevented from excessively compressing the case or excessively exceeding the side of the case assembly.

In the present embodiment, the first opening angle is in a range between degrees and 31 degrees, such as 25 degrees, 27 degrees, 31 degrees, and so on.

In the present embodiment, the first initial angle is in a range between +33 degrees and +23 degrees, such as +33 degrees, +28 degrees, +23 degrees, and so on. A first termination angle is in a range between −5 degrees and −15 degrees, such as −5 degrees, −10 degrees, −15 degrees, and so on. The second angle θ22 is in a range between +78 degrees and +64 degrees, such as +78 degrees, +72 degrees, +64 degrees, and so on.

In the present embodiment, when the door 220 is rotated from the closed state to the position of the first opening angle relative to the case, a ratio of a length of the trajectory of the inner shaft 260 moving relative to the inner slot 240 to a length of the trajectory of the outer shaft 250 moving relative to the outer slot 270 is in a range of between 1.5 and 1.7, such as 1.5, 1.56, 1.6, 1.7, and so on. In this way, the door 220 is enabled to be rotated relative to the case 210, in the counterclockwise direction, as shown in FIG. 24.

As shown in FIG. 30, while the door 220 is being opened from the position of the first opening angle relative to the case to the position of the second opening angle relative to the case, the first angle θ21 gradually increases from a second initial angle, which has an absolute value of less than 90 degrees, to a second termination angle. The second angle θ22 is gradually increased from a third initial angle, which is less than 90 degrees and is expressed as a positive value, to a third termination angle. A difference between the second angle θ22 and the first angle θ21, corresponding to the same opening angle between the door 220 and the case, is at least firstly gradually increased to counteract an increase in a projection of a connection line between the outer shaft 250 and the outer edge 222 onto the first reference plane 223 and to counteract an increase in a projection of a connection line between the outer shaft 250 and the inner edge 221 onto the second reference plane 224. In this way, the door 220 is prevented from exceeding the side of the case 210 (i.e., the second reference plane 224) and from excessively compressing the case 210, while the door 220 is being opened.

In the present embodiment, the second opening angle is in a range between 57 degrees and 60 degrees, such as 57 degrees, 58 degrees, 60, and so on.

In the present embodiment, the second initial angle is in a range between −5 degrees and −15 degrees, such as −5 degrees, −10 degrees, −15 degrees, and so on. The second termination angle is in a range between +37 degrees and +47 degrees, such as +37 degrees, +42 degrees, +47 degrees, and so on. The third initial angle is in a range between +65 degrees and +75 degrees, such as +65 degrees, +70 degrees, +75 degrees, and so on. The third termination angle is in a range between +108 degrees and +118 degrees, such as +118 degrees, +123 degrees, +118 degrees, and so on.

In the present embodiment, while the door 220 is rotated from the position of the first opening angle relative to the case to the position of the second opening angle relative to the case, a ratio of a length of the trajectory of the inner shaft 260 moving relative to the inner slot 240 to a length of the trajectory of the outer shaft 250 moving relative to the outer slot 270 is in a range between 2.1 and 2.3, such as 2.1, 2.18, 2.2, 2.3 and so on. In this way, the door 220 is enabled to move relative to the case 210 in the counterclockwise direction as shown in FIG. 24.

In the present embodiment, the thickness of the door 220 (i.e., the length of the door 220 in a direction parallel to the second reference plane 224) is t. While the door 220 is being rotated, under the action of the hinge assembly 230, from the closed position to the position of the maximum opening angle with respect to the case 210, a distance between the center of the inner shaft 260 and the first reference plane 223 is in a range between 0.75t and such as 0.75t, 0.76t, 0.77t, and so on. A distance between the center of the inner shaft 260 and the second reference plane 224 is in a range between 0.79t and 0.81t, such as 0.79t, 0.80t, and so on. When the door 220 is in the closed state, a distance between the outer shaft 250 and the first reference plane 223 is in a range between 0.55t and 0.57t, such as 0.55t, 0.56t, 0.57t, and so on. A distance between the outer shaft 250 and the second reference plane 224 is in a range between 0.22t and 0.24t, such as 0.22t, 0.23t, 0.24t, and so on. When the angle between the door 220 and the case is the first opening angle, a distance between the center of the outer shaft 250 and the first reference plane 223 is in a range between 0.59t and 0.61t, such as 0.59t, 0.60t, 0.61t, and so on; and a distance between the center of the outer shaft 250 and the second reference plane 224 is in a range between 0.40t and 0.42t, such as 0.40t, 0.41t, 0.42t, and so on. When angle between the door body 220 and the case is the second opening angle, a distance between the center of the outer shaft 250 and the first reference plane 223 is in a range between and 0.61t, such as 0.59t, 0.60t, 0.61t, and so on; a distance between the center of the outer shaft 250 and the second reference plane 224 is in a range between 0.49t and 0.51t, such as 0.49t, 0.51t, and so on.

In the present embodiment, a point of the door 220 is determined as a reference point. The reference point coincides with the center of the outer shaft 250 when the outer shaft 250 is located at the termination position of the outer slot 270. A process of the first perpendicular distance from the reference point to the outer edge 222 and the second perpendicular distance from the reference point to the inner edge 221 being changed may be similar to that in the above-mentioned third embodiment of the case assembly 10, and will not be repeated herein.

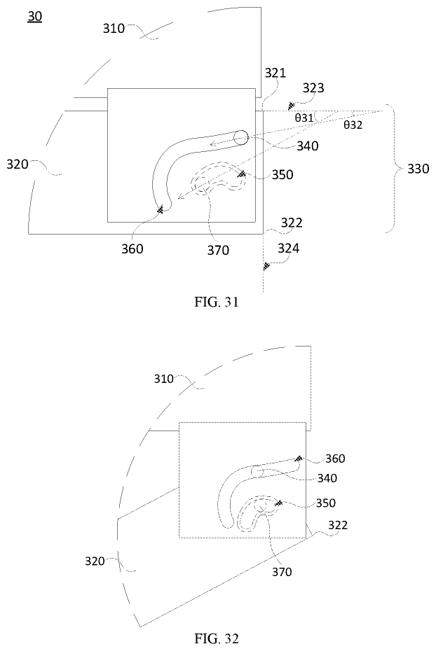

As shown in FIG. 31, in a fifth embodiment of the present disclosure, the case assembly 30 includes a case 310, a door 320, and a hinge assembly 330. The case 310 defines a receiving space, and the receiving space has an opening. The door 320 covers the opening to block the opening. The hinge assembly 330 is disposed at a pivot side of the case 310. The hinge assembly 330 is configured to pivotally connect the case 310 to the door 320. Definitions of the inner edge 321 of the door 320, the outer edge 322 of the door 320, the first reference plane 323, and the second reference plane 324 may be referred to the definitions of the case assembly 10 in the third embodiment of the present disclosure, and will not be repeated herein.

Differences between the present embedment and the above embodiments are as follows. In the present embodiment, the inner shaft 340 and the outer slot 350 of the hinge assembly 330 are disposed on the door 320, and the inner slot 360 and the outer shaft 370 of the hinge assembly 330 are disposed on the case 310. The outer slot 350 is engaged with the outer shaft 370, such that the center of the outer shaft 370 serves as the first hinge point. The inner slot 360 is engaged with the inner shaft 340, such that the center of the inner shaft 340 serves as the second hinge point. The second hinge point is disposed, compared to the first hinge point, away from the outer edge 322. In the process of opening the door 320 relative to the case 310 under the action of the hinge assembly 330, the door 320 moves in a first movement direction relative to the case 310 at the first hinge point and moves in a second movement direction relative to the case 310 at the second hinge point. A first angle θ31 is generated between the first movement direction and the first reference plane 323, and a second angle θ32 is generated between the second movement direction and the first reference plane 323. Definitions of the first angle θ31 and the second angle θ32 may be referred to the description in the third embodiment of the case assembly 10 in the above, and will not be repeated herein.

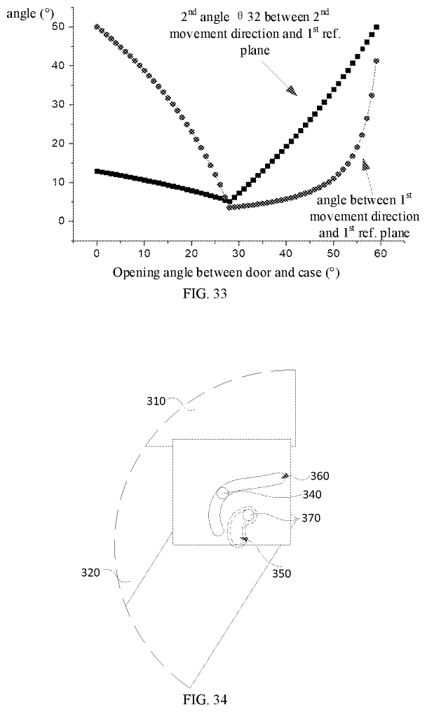

As shown in FIG. 32 and FIG. 33, in the process of rotating the door 320 from the closed state to the position of the first opening angle relative to the case, the second angle θ32 is positive and less than 90 degrees; the first angle θ31 gradually decreases from a first initial angle, which is positive and less than 90 degrees, to a first termination angle; and a difference between the second angle θ32 and the first angle θ31, corresponding to the same opening angle between the door 320 and the case 310, gradually increases. From the perspective of motion relationships, the above motion trends at the two hinge points correspond to motions of the door relative to the case, and the motions include rotation and movement. The movement has a tendency of moving away from the first reference plane and the second reference plane, counteracting a tendency of the door compressing the case and exceeding the side of the case assembly. Therefore, in the present disclosure, the door is prevented from excessively compressing the case or excessively exceeding the side of the case assembly.

In the present embodiment, the first opening angle between the door and the case is in a range between 25 degrees and 31 degrees, such as 25 degrees, 29 degrees, 31 degrees, and so on.

In the present embodiment, the first initial angle is in a range between +55 degrees and +45 degrees, such as +55 degrees, +50 degrees, +45 degrees, and so on. The first termination angle is in a range between +1 degrees and +11 degrees, such as +1 degrees, +6, +11 degrees, and so on. The second angle θ32 is in a range between +0 degrees and +18 degrees, specifically between 5 degrees and 13 degrees, such as +0 degrees, +9 degrees, +18 degrees, and so on, and is gradually decreased.

In the present embodiment, when the door 320 is rotated from the closed state to the position of the first opening angle relative to the case, a ratio of a length of the trajectory of the inner shaft 340 moving relative to the inner slot 360 to a length of the trajectory of the outer shaft 370 moving relative to the outer slot 350 is in a range of from 1.5 to 1.7, such as 1.5, 1.58, 1.6, 1.7 and so on. In this way, the door 320 is enabled to be rotated relative to the case 310 in the counterclockwise direction as shown in FIG. 26.

As shown in FIG. 34, while the door 320 is being opened from the position of the first opening angle relative to the case to the position of the second opening angle relative to the case, the first angle θ31 gradually increases from a second initial angle, which has an absolute value of less than 90 degrees, to a second termination angle; the second angle θ32 gradually increases from a third initial angle, which is positive and is less than 90 degrees, to a third termination angle; and a difference between the second angle θ32 and the first angle θ31, corresponding to the same opening angle between the door 320 and the case 310, at least firstly gradually increases to encounter an increase in a projection of a connection line between the outer shaft 370 and the outer edge 322 onto the first reference plane 323 and to encounter an increase of a projection of a connection line between the outer shaft 370 and the inner edge 321 onto the second reference plane 324. In this way, the door 320 is prevented from exceeding the side of the case 310 (i.e., the second reference plane 324) and from excessively compressing the case 310, while the door is being opened.

In the present embodiment, the second opening angle between the door and the case is in a range between 57 degrees and 60 degrees, such as 57 degrees, 58 degrees, 60 degrees, and so on.

In the present embodiment, the second initial angle is in a range between +1 degrees and +11 degrees, such as +1 degrees, +6 degrees, +11 degrees, and so on. The second termination angle is in a range between +36 degrees and +46 degrees, such as +36 degrees, +41 degrees, +46 degrees, and so on. The third initial angle is in a range between 0 degrees and +10 degrees, such as 0 degrees, 5 degrees, or 10 degrees, and so on. The third termination angle is in a range between +45 and +55 degrees, such as +45 degrees, +50 degrees, +55 degrees, and so on.

In the present embodiment, while the door 320 is rotated from the position of the first opening angle relative to the case to the position of the second opening angle relative to the case, a ratio of a length of the trajectory of the inner shaft 340 moving relative to the inner slot 360 to a length of the trajectory of the outer shaft 370 moving relative to the outer slot 350 is in a range of from 3.0 to 3.2, such as 3.0, 3.1, 3.13, 3.2 and so on. In this way, the door 320 is enabled to be rotated relative to the case 310 in the counterclockwise direction as shown in FIG. 26.

In the present embodiment, the thickness of the door 320 (i.e., the length of the door 320 in a direction parallel to the second reference plane 324) is t. While the door 320 is being opened, under the action of the hinge assembly 330, from the closed state to the position of the maximum angle with respect to the case 310, a distance between the outer shaft 370 and the first reference plane 323 is in a range between 0.59t and 0.61t, such as 0.59t, 0.60t, 0.61t, and so on; a distance between the center of the outer shaft 370 and the second reference plane 324 is in a range between 0.49t and 0.51t, such as 0.49t, 0.50t, 0.51t, and so on. When the door 320 is in the closed state, a distance between the center of the inner shaft 340 and the first reference plane 323 is in a range between 0.21t and 0.23t, such as 0.21t, 0.22t, 0.23t, and so on; a distance between the center of the inner shaft 340 and the second reference plane 324 is in a range between 0.17t and 0.19t, such as 0.17t, 0.18t, 0.19t, and so on. When the angle between the door 320 and the case is the first opening angle, a distance between the center of the inner shaft 340 and the first reference plane 323 is in a range between 0.27t and 0.29t, such as 0.27t, 0.28t, 0.29t, and so on; a distance between the center of the inner shaft 340 and the second reference plane 324 is in a range between 0.52t and 0.54t, such as 0.52t, 0.53t, 0.54t, and so on. When the angle between the door 320 and the case is the second opening angle, a distance between the center of the inner shaft 340 and the first reference plane 323 is in a range between 0.37t and 0.39t, such as 0.38t, 0.39t, and so on; a distance between the center of the inner shaft 340 and the second reference plane 324 is in a range between 0.76t and 0.78t between, such as 0.76t, 0.77t, 0.78t, and so on.

In the present embodiment, a point of the door 320 is determined as a reference point. The reference point coincides with the first hinge point. A process of the first perpendicular distance from the reference point to the outer edge 322 and the second perpendicular distance from the reference point to the inner edge 321 being changed is similar to that described in the above third embodiment of the case assembly 10, and will not be repeated herein.

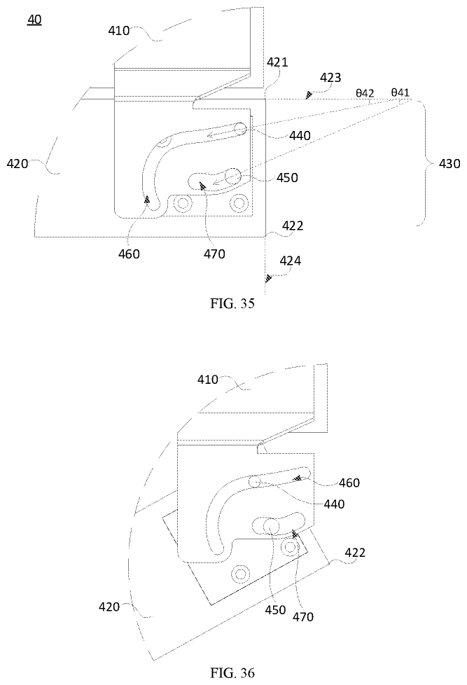

As shown in FIG. 35, in a sixth embodiment of the present disclosure, the case assembly 40 includes a case 410, a door 420, and a hinge assembly 430. The case 410 defines a receiving space, and the receiving space has an opening. The door 420 covers the opening to block the opening. The hinge assembly 430 is disposed at a pivot side of the case 410, the hinge assembly 430 is configured to pivotally connect the case 410 to the door 420. Definitions of the inner edge 421, the outer edge 422, the first reference plane 423, and the second reference plane 424 of the door 420 are referred to the definitions in the third embodiment of the case assembly 10 as described above, and will not be repeated herein.

Differences between the present embedment and the above embodiments are as follows. In the present embodiment, the inner shaft 440 and the outer shaft 450 of the hinge assembly 430 are disposed on the door 420, and the inner slot 460 and the outer slot 470 of the hinge assembly 430 are defined in the case 410. The outer slot 470 is engaged with the outer shaft 450, such that the center of the outer shaft 450 serves as a first hinge point. The inner slot 460 is engaged with the inner shaft 440, such that the center of the inner shaft 440 serves as a second hinge point. The second hinge point is disposed, compared to the first hinge point, away from the outer edge 422. While the door 420 is being opened relative to the case 410 under the action of the hinge assembly 430, the door 420 moves in a first movement direction relative to the case 410 at the first hinge point and moves in a second movement direction relative to the case 410 at the second hinge point. A first angle θ41 is generated between the first movement direction and the first reference plane 423, and a second angle θ42 is generated between the second movement direction and the first reference plane 423. Definitions of the first angle θ41 and the second angle θ42 are referred to the definitions in the third embodiment of the case assembly 10 as described in the above, and will not be repeated herein.

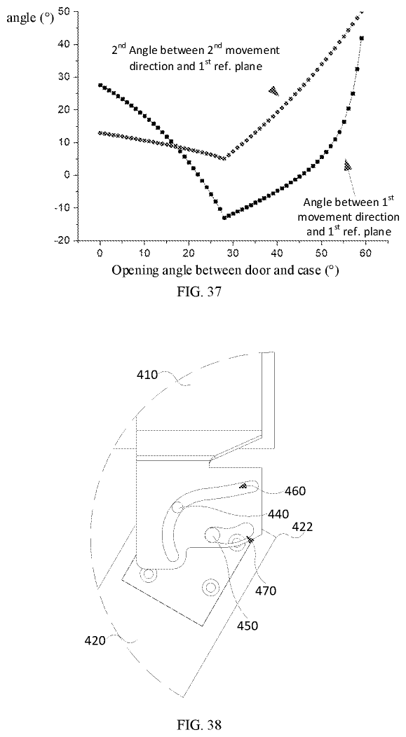

As shown in FIG. 36 and FIG. 37, in the process of rotating the door 420 from the closed state to the position of the first opening angle relative to the case, the second angle θ42 is positive and less than 90 degrees; the first angle θ41 gradually decreases from a first initial angle, which is positive and less than 90 degrees, to a first termination angle; and a difference between the second angle θ42 and the first angle θ41, corresponding to the same opening angle between the door 420 and the case 410, gradually increases. From the perspective of motion relationships, the above motion trends at the two hinge points correspond to motions of the door relative to the case, and the motions include rotation and movement. The movement has a tendency of moving away from the first reference plane and the second reference plane, counteracting a tendency of the door compressing the case and exceeding the side of the case assembly. Therefore, in the present disclosure, the door is prevented from excessively compressing the case or excessively exceeding the side of the case assembly.

In the present embodiment, the first opening angle is in a range between degrees and 31 degrees, such as 25 degrees, 27 degrees, 31 degrees, and so on.

In the present embodiment, the first initial angle is in a range between +33 degrees and +23 degrees, such as +33 degrees, +28 degrees, +23 degrees, and so on. The first termination angle is in a range between −5 degrees and −15 degrees, such as −5 degrees, −10 degrees, −15 degrees, and so on. The second angle θ22 is in a range between +0 degrees and +18 degrees, such as +0 degrees, +8 degrees, +18 degrees, and so on, and is gradually decreased.

In the present embodiment, when the door 420 is rotated from the closed state to the position of the first opening angle relative to the case, a ratio of a length of the trajectory of the inner shaft 440 moving relative to the inner slot 460 to a length of the trajectory of the outer shaft 450 moving relative to the outer slot 470 is in a range of between 1.8 and 2.0, such as 1.8, 1.87, 1.9, 2.0, and so on. In this way, the door 420 is enabled to be rotated relative to the case 410 in the counterclockwise direction as shown in FIG. 28.

As shown in FIG. 38, while the door 420 is being opened from the position of the first opening angle relative to the case to the position of the second opening angle relative to the case, the first angle θ41 gradually increases from a second initial angle, which has an absolute value of less than 90 degrees, to a second termination angle; the second angle θ42 gradually increases from a third initial angle, which is expressed as a positive value and is less than 90 degrees, to a third termination angle; and a difference between the second angle θ42 and the first angle θ41, corresponding to the same opening angle between the door 420 and the case 410, at least firstly gradually increases to counteract an increase in a projection of a connection line between the outer shaft 450 and the outer edge 422 onto the first reference plane 423 and to counteract an increase in a projection of a connection line between the outer shaft 450 and the inner edge 421 onto the second reference plane 424. In this way, the door 420 is prevented from exceeding the side of the case 410 (i.e., the second reference plane 424) and from excessively compressing the case 420, while the door is being opened.

In the present embodiment, the second opening angle between the door and the case is in a range between 57 degrees and 60 degrees, such as 57 degrees, 58 degrees, 60 degrees, and so on.

In the present embodiment, the second initial angle is in a range between −5 degrees and −15 degrees, such as −5 degrees, −10 degrees, −15 degrees, and so on. The second termination angle is in a range between +37 degrees and +47 degrees, such as +37 degrees, +42 degrees, +47 degrees, and so on. The third initial angle is in a range between +0 degrees and +10 degrees, such as +0 degrees, +6 degrees, +10 degrees, and so on. The third termination angle is in a range between +45 degrees and +55 degrees, such as +45 degrees, +51 degrees, +55 degrees, and so on.

In the present embodiment, when the door 420 is rotated to be opened from the position of the first opening angle relative to the case to the position of the second opening angle relative to the case, a ratio of a length of the trajectory of the inner shaft 440 moving relative to the inner slot 460 to a length of the trajectory of the outer shaft 450 moving relative to the outer slot 470 is in a range between 3.0 and 3.2, such as 3.0, 3.1, 3.2 and so on. In this way, the door 420 is enabled to be rotated relative to the case 410 in the counterclockwise direction as shown in FIG. 28.

In the present embodiment, the thickness of the door 420 (i.e., the length of the door 420 in a direction parallel to the second reference plane 424) is t. When the door 420 is in the closed state, a distance between the center of the inner shaft 440 and the first reference plane 423 is in a range between 0.21t and 0.23t, such as 0.21t, 0.22t, 0.23t, and so on; a distance between the center of the inner shaft 440 and the second reference plane 424 is in a range between 0.17t and 0.19t, such as 0.17t, 0.18t, 0.19t, and so on; a distance between the center of the outer shaft 450 and the first reference plane 423 is in a range between 0.55t and 0.57t, such as 0.56t, 0.57t, and so on; and a distance between the center of the outer shaft 450 and the second reference plane 424 is in a range of between 0.22t and 0.24t, such as 0.22t, 0.23t, 0.24t, and so on. When the angle between the door 420 and the case is the first opening angle, a distance between the center of the inner shaft 440 and the first reference plane 423 is in a range between 0.27t and 0.29t, such as 0.27t, 0.28t, 0.29t, and so on; a distance between the center of the inner shaft 440 and the second reference plane 424 is in a range between 0.52t and 0.54t, such as 0.52t, 0.53t, 0.54t, and so on; a distance between the center of the outer shaft 450 and the first reference plane 423 is in a range between 0.59t and 0.61t, such as 0.59t, 0.60t, 0.61t, and so on; and a distance between the center of the outer shaft 450 and the second reference plane 424 is in a range between 0.40t and 0.42t, such as 0.40t, 0.41t, 0.42t, and so on. When the angle between the door 420 and the case is the second opening angle, a distance between the center of the inner shaft 440 and the first reference plane 423 is in a range between 0.37t and 0.39t, such as 0.38t, 0.39t, and so on; a distance between the center of the inner shaft 440 and the second reference plane 424 is in a range between 0.76t and 0.78t, such as 0.76t, 0.77t, 0.78t, and so on; a distance between the center of the outer shaft 450 and the first reference plane 423 is in a range between 0.59t and 0.61t, such as 0.59t, 0.60t, 0.61t, and so on; and a distance between the center of the outer shaft 450 and the second reference plane 424 is in a range between 0.49t and 0.51t, such as 0.49t, 0.50t, 0.51t, and so on.

In the present embodiment, a point of the door 420 is determined as a reference point. The reference point coincides with the center of the outer shaft 450 when the outer shaft 450 is located at the termination position of the outer slot 470. A process of the first perpendicular distance from the reference point to the outer edge 422 and the second perpendicular distance from the reference point to the inner edge 421 being changed is similar to that in the third embodiment of the above-mentioned case assembly 10, and will not be repeated herein.

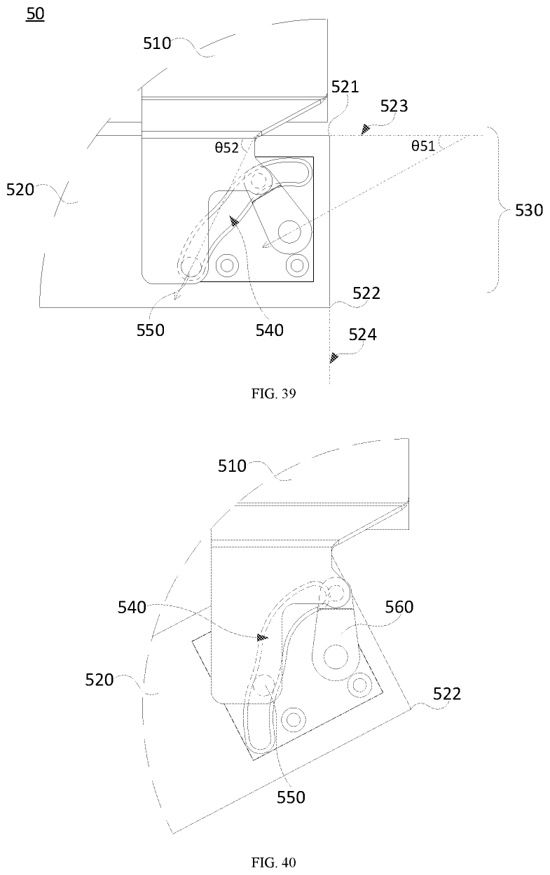

As shown in FIG. 39, in a seventh embodiment of the present disclosure, the case assembly 50 includes a case 510, a door 520, and a hinge assembly 530. The case 510 defines a receiving space, and the receiving space has an opening. The door 520 covers the opening to block the opening. The hinge assembly 530 is disposed at a pivot side of the case 510. The hinge assembly 530 is configured to pivotally connect the case 510 to the door 520. Definitions of the inner edge 521, the outer edge 522, the first reference plane 523, and the second reference plane 524 of the door 520 are referred to the definitions in the third embodiment of the case assembly 10 as described in the above, and will not be repeated herein.

Differences between the present embedment and the above embodiments are as follows. In the present embodiment, the hinge assembly 530 includes a slot 540 defined in the door 520 and a shaft 550 arranged on the case. The slot 540 is engaged with the shaft 550, such that a center of the shaft 550 serves as a second hinge point. The hinge assembly 530 further includes a connecting rod 560. An end of the connecting rod 560 is connected with the door 520 and serves as a first hinge point. The other end of the connecting rod 560 is hinged to the case 510. The second hinge point is disposed, compared to the first hinge point, away from the outer edge 522. While the door 520 is being opened, under the action of the hinge assembly 530, relative to the case 510, the door 520 moves in a first movement direction relative to the case 510 at the first hinge point and moves in a second movement direction relative to the case 510 at the second hinge point. A first angle θ51 is generated between the first movement direction and the first reference plane 523, and a second angle θ52 is generated between the second movement direction and the first reference plane 523. Definitions of the first angle θ51 and the second angle θ52 are referred to the third embodiment of the case assembly 10 as described in the above, and will not be repeated herein.

As shown in FIG. 40, in the process of rotating the door 520 from the closed state to the position of the first opening angle relative to the case, the second angle θ52 is positive and less than 90 degrees; the first angle θ51 gradually decreases from a first initial angle, which is positive and less than 90 degrees, to a first termination angle; and a difference between the second angle θ52 and the first angle θ51, corresponding to the same opening angle between the door 520 and the case 510, gradually increases. From the perspective of motion relationships, the above motion trends at the two hinge points correspond to motions of the door relative to the case, and the motions include rotation and movement. The movement has a tendency of moving away from the first reference plane and the second reference plane, counteracting a tendency of the door compressing the case and exceeding the side of the case assembly. Therefore, in the present disclosure, the door is prevented from excessively compressing the case or excessively exceeding the side of the case assembly.

In the present embodiment, the first opening angle between the door and the case is in a range between 25 degrees and 31 degrees, such as 25 degrees, 27 degrees, or 31 degrees.

In the present embodiment, the first initial angle is in a range between +36 degrees and +26 degrees, such as +36 degrees, +31 degrees, +26 degrees, and so on. The first termination angle is in a range between −5 degrees and +5 degrees, such as −5 degrees, 0 degrees, +5 degrees, and so on. The second angle θ52 is in a range between +78 degrees and +64 degrees, such as +78 degrees, +71 degrees, +64 degrees, and so on.

As shown in FIG. 41, in the present embodiment, while the door 520 is being opened from the position of the first opening angle relative to the case to the position of the second opening angle relative to the case, the first angle θ51 is further decreased, and the second angle θ52 is gradually increased from a second initial angle, which is positive and less than 90 degrees, to a second termination angle.

In the present embodiment, the first angle θ 51 is further decreased to reach a range between −9 degrees and −19 degrees, such as −9 degrees, −14 degrees, −19 degrees, and so on. The second initial angle is in a range between +64 degrees and +74 degrees, such as +64 degrees, +69 degrees, +74 degrees, and so on. The second termination angle is in a range between +108 degrees and +118 degrees, such as +108 degrees, +113 degrees, +118 degrees, and so on.

Based on the above-described embodiments, the case assembly of the present disclosure includes the case, the door, and the hinge assembly. The case defines the receiving space, and the receiving space has the opening. The door covers the opening to block the opening. The hinge assembly is disposed at the pivotal side of the case. The hinge assembly is configured to pivotally connect the case to the door. The door has the inner edge and the outer edge located on the pivotal side. The case assembly has the first reference plane and the second reference plane. The first reference plane, when the door is in the closed state, passes through the inner edge and is parallel to the plane on which the opening is located. The second reference plane, when the door is in the closed state, passes through the outer edge and is perpendicular to the plane on which the opening is located. The first reference plane and the second reference plane are not displaced with respect to the case when the door is being opened with respect to the case.

The hinge assembly has the first hinge point and the second hinge point. The second hinge point is disposed, compared to the first hinge point, away from the outer edge. In the process of opening, under the action of the hinge assembly, the door relative to the case, the door moves in the first movement direction relative to the case at the first hinge point and moves in the second movement direction relative to the case at the second hinge point. The first angle is generated between the first movement direction and the first reference plane, and the second angle is generated between the second movement direction and the first reference plane. When the first movement direction is extending away from the first reference plane, the first angle is a positive value. When the first movement direction is extending away from the second reference plane, the absolute value of the first angle is less than 90 degrees. When the second movement direction is extending away from the second reference plane, the second angle is a positive value. When the second movement direction is extending away from the second reference plane, the absolute value of the second angle is less than 90 degrees.

In the process of rotating the door from the closed state to the position of the first opening angle relative to the case, the second angle is positive and less than 90 degrees; the first angle gradually decreases from the first initial angle, which is positive and less than 90 degrees, to the first termination angle; and the difference between the second angle and the first angle, corresponding to the same opening angle between the door and the case, gradually increases. In the process of rotating the door from the position of the first opening angle relative to the case to the position of the second opening angle relative to the case, the first angle gradually increases from the second initial angle, which has an absolute value of less than 90 degrees, to the second termination angle; the second angle gradually increases from the third initial angle, which is positive and less than 90 degrees, to the third termination angle; and the difference between the second angle and the first angle, corresponding to the same opening angle between the door and the case, at least firstly gradually increases.

In addition, in the process of opening, under the action of the hinge assembly, the door from the closed state to the position of the maximum angle with respect to the case, the first hinge point moves from the starting position to the termination position. A point of the door is further determined as the reference point. The reference point coincides with one of the starting position or the termination position of the first hinge point, and the coinciding one of the starting position or the termination position refers to the position located furthest away from the second reference plane. In addition, while the door is being opened, the reference point is not displaced with respect to the case. A first perpendicular line is generated from the reference point to the outer edge, and a first perpendicular distance is generated, along the first perpendicular line, from the reference point to the outer edge. A second perpendicular line is generated from the reference point to the inner edge, and a second perpendicular distance is generated, along the second perpendicular line, from the reference point to the inner edge. A third angle is generated between the first perpendicular line and the first reference plane, and a fourth angle is generated between the second perpendicular line and the first reference plane. In the process of rotating the door from the closed state to the position of the first opening angle with respect to the case, the first perpendicular distance and the second perpendicular distance are gradually decreased; the third angle is gradually decreased within the range between 0 degrees and 90 degrees; and the fourth angle is gradually increased within the range between 0 degrees and 90 degrees. In the process of rotating the door from the position of the first opening angle relative to the case to the position of second opening angle with respect to the case, the first perpendicular distance is gradually decreased; the third angle is gradually decreased within the range between 0 degrees and 90 degrees; and the fourth angle is gradually increased and exceeds 90 degrees when the angle between the door and the case is within the predetermined angle range and before the second opening angle is reached. The second perpendicular distance is gradually increased when the angle between the door and the case is within the predetermined angle range.

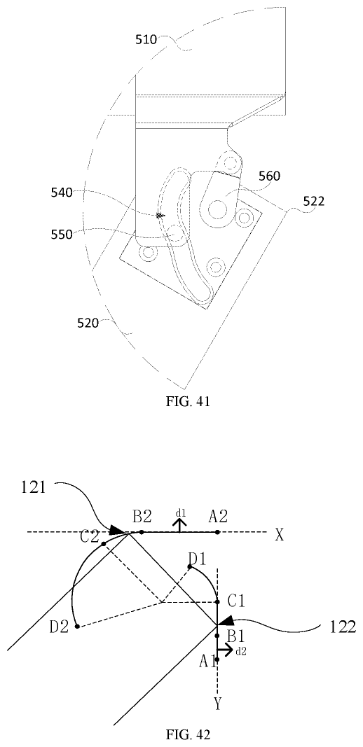

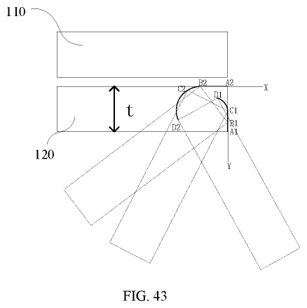

For the hinge assembly described above, the door 120 may rotate relative to the case 110, and the inner edge 121 and outer edge 122 of the door 120 have certain trajectories relative to each other, as shown in FIG. 42 and FIG. 43.

While the door 120 is being opened, under the action of the hinge assembly 130, from the closed state to the position of the first opening angle relative to the case, the outer edge 122 moves along the first outer edge trajectory A1B1 towards the first reference plane X, and the inner edge 121 moves along the first inner edge trajectory A2B2 towards the side of the second reference plane Y facing towards the opening. For movements of the outer edge 121 and the inner edge 122 in their respective directions, the radius of curvature of the first outer edge trajectory A1B1 is greater than or equal to 5t, and the distance of the first outer edge trajectory A1B1 exceeding the side of the second reference plane Y away from the opening is less than or equal to the first predetermined distance d1. The radius of curvature of the first inner edge trajectory A2B2 is greater than or equal to 100t, and the distance of the first inner edge trajectory A2B2 exceeding the side of the first reference plane X facing toward the opening is less than or equal to the second predetermined distance d2. The t is the thickness of the door. Based on the radiuses of curvature of the movement trajectories, and based on the limitation of the distances of the trajectories exceeding the reference planes, the door is able to move smoothly without exceeding a predetermined range.

Specific values of the first predetermined distance and the second predetermined distance may be determined based on demands of actual products. For example, the first predetermined distance may be determined according to the distance between the case assembly and the wall in which the case assembly is embedded, and the second distance may be determined according to a thickness or elasticity of a door block for the case. The thickness of the door is taken in the present embodiment as a reference, and the first predetermined distance and the second predetermined distance are limited to be within the range of 0-0.15 times of the thickness of the door. When 0 times is determined, the door is limited as not compressing the case or exceeding the side of the case assembly. In the present embodiment, 0.1 times is determined, and that is, the distance that the door exceeds the side of the case assembly is allowed to be 0.1 times of the thickness of the door. Alternatively, the first predetermined distance and the second predetermined distance may be determined based on experiences. The first predetermined distance may be determined within the range between 0 mm and 4 mm, and the second predetermined distance may be determined within the range between 0 mm and 2 mm. Similarly, when each of the first predetermined distance and the second predetermined distance is 0 mm, the door does not exceed the side of the case assembly. In the present embodiment, the first predetermined distance is 3 mm, and the second predetermined distance is 1 mm, and that is the allowed distance of the door exceeding the side of the case.

Further, in the present embodiment, the end point B2 of the first inner edge trajectory A2B2 is located on the first reference plane X. Alternatively, the end point B2 is located on the side of the first reference plane X away from the opening, and the distance from the end point B2 to the first reference plane X is less than or equal to 0.058t. The end point B1 of the first outer edge trajectory A1B1 is located on the second reference plane Y. Alternatively, the end point B1 is located on the side of the second reference plane Y facing towards the opening, and the distance from the end point B1 to the second reference plane Y is less than or equal to That is, after the door body 120 is opened to reach the position of the first opening angle relative to the case, the inner edge 122 of the door 120 does not compress the case 110 and does not move excessively away from the case 110. The outer edge 121 does not extend beyond the side of the case assembly 100 and does not move excessively towards the side of the second reference plane Y facing towards the opening. In this way, the door 12 is not displaced obviously while being opened, and the door 120 may move more stably.

When the door 120 is opened from the position of the first opening angle relative to the case to the position of the second opening angle relative to the case, the inner edge 121 moves along the second inner edge trajectory to the side of the second reference plane Y facing the opening and towards the side of the first reference plane X away from the opening; and the radius of curvature of the second inner edge trajectory decreases gradually. The outer edge 122 moves along the second outer edge trajectory towards the first reference plane X. The radius of curvature of the second outer edge trajectory is greater than or equal to 5t. The distance of the second outer edge trajectory exceeding the side of the second reference plane away from the opening is less than or equal to the first predetermined distance. The second inner edge trajectory may be the trajectory A2C2, and the second outer edge trajectory may be the trajectory A1C1.

The movement direction in which the inner edge 121 moves along the second inner edge trajectory is away from the opening of the case, such that the door may be prevented from compressing the case. The radius of curvature of the second outer edge trajectory of the outer edge trajectory 122 is greater than or equal to 5t, and the distance of the second outer edge trajectory exceeding the side of the second reference plane away from the opening is less than or equal to the first predetermined distance. By analyzing the first outer edge trajectory, the above features prevent the door from exceeding the side of the case assembly.

Under the action of the hinge assembly 130, the door 120 may further be opened from the position of the second opening angle relative to the case to the position of the third opening angle relative to the case 110. In this process, the inner edge 121 moves along the third inner edge trajectory C2D2 toward the side of the first reference plane X away from the opening, and the outer edge 122 moves along the third outer prong trajectory C1D1 toward the side of the second reference plane Y facing toward the opening. The trajectories in this movement direction correspond to a greater opening angle between the door 120 and the case.

The third inner edge trajectory C2D2 and the third outer edge trajectory C1D1 are circular arcs that are concentrically with each other. The third inner edge trajectory C2D2 has the radius of curvature of 0.55t-0.67t, and the third outer edge trajectory C1D1 has the radius of curvature of 0.45t-0.55t.

Details of the three trajectories are as follows. The first trajectories correspond to the first opening angle of 25 degrees to 31 degrees between the door 12 and the case 11. The second trajectories correspond to the second opening angle of 57 degrees to 60 degrees between the door 12 and the case 11. The third trajectories correspond to the third opening angle of 122 degrees to 132 degrees between the door 12 and the case 11.

The length of the first inner edge trajectory A2B2 is 0.465t, and the length of the first outer edge trajectory A1B1 is 0.115t.

The length of the second outer edge trajectory B1C1 is 0.2285t, and the second inner edge trajectory B2C2 is set to allow the distance of the inner edge 121 moving on the second inner edge trajectory B2C2 and an angle of the door 12 rotating relative to the case 11 to satisfy the following formula:

$$θ 1 = \frac{t 1}{t} θ$$

The θ1 is the rotating angle, the θ is a predetermined angle of 100 degrees-113 degrees, and the t1 is the moving distance.

A center of the third inner edge trajectory C2D2 is located inside the door 12. The radius of curvature of the third inner edge trajectory C2D2 is 0.61t. A center of the third outer edge trajectory C1D1 is located inside the door 12. The radius of curvature of the third outer edge trajectory C1D1 is 0.5t. A distance from the center of the third edge trajectories to the first reference plane X is 0.6t, and a distance from the center of the third edge trajectories to the second reference plane Y is 0.5t.

In an embodiment, the hinge assembly includes an inner shaft 160 and an inner slot 140. The inner shaft 160 is arranged on one of the case 11 and the door 12, and the inner slot 140 is defined in the other one of the case 11 and the door 12. When the door 12 is in the closed state, the inner shaft 160 is spaced apart from a wall of an end of the inner slot 140 away from the inner edge. The closed state refers to the normal closed state.

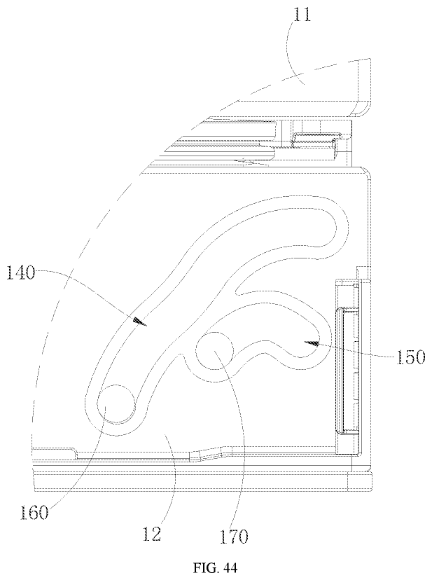

Specifically, as shown in FIG. 44, when the door 12 is in the normal closed state, the inner shaft 160 is spaced apart from the wall of the end of the inner slot 140 away from the inner edge, such that a gap is defined between the inner shaft 160 and the wall of the end of the inner slot 140. When the door is being closed abnormally, for example, when the door is being closed by the relatively large force, the door, after being normally closed relative to the case, may further compress the case, allowing the inner shaft 160 to further move to be received in the gap. Therefore, the inner shaft 160 may not be blocked, vibration of the case assembly may be reduced, and the door may be closed more stably. When the door is in the normal closed state, the inner shaft 160 may not be received in the gap.

In an embodiment, when the door 12 at the position of the maximum opening angle relative to the case, the inner shaft 160 is spaced apart from a wall of an end of the inner slot 140 near the inner edge. The maximum opening angle is the maximum angle between the door and the case when the door is being opened normally.

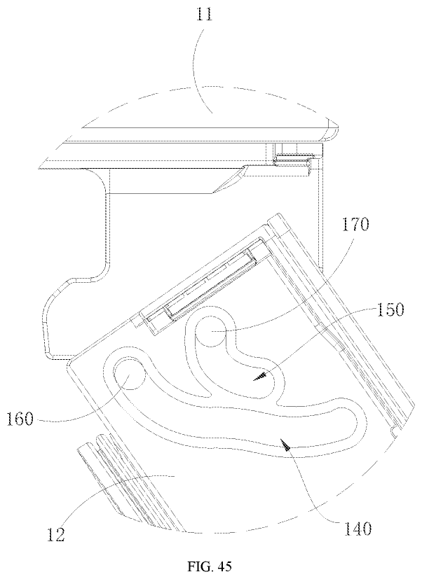

Specifically, as shown in FIG. 45, when the door 12 is being opened normally, the inner shaft 160 is spaced apart from the wall of the end of the inner slot 140 near the inner edge, such that a gap is defined between the inner shaft 160 and the wall of the end of the inner slot 140. When the door is being opened abnormally, for example, when the door is opened by a relatively large opening force, the door may move, after being opened relative to the case, further away from the case, enabling the inner shaft 160 to further move to be received in the gap. Therefore, the inner shaft 160 may not be blocked, vibration of the case assembly may be reduced, and the door may be closed more stably. When the door is being opened normally, the inner shaft 160 may not be received in the gap.

To summarize the above, various hinge assemblies that conform to the concepts of the present disclosure all can solve the problem of the door compressing the case and exceeding the side of the case assembly while the door is being opened. The case assembly as described in the above may be applied to any door which may compress the case and have interference when exceeding the case assembly, such as a refrigerator, a cabinet, and so on.

The present disclosure further provides a refrigeration apparatus. The refrigeration apparatus includes the case assembly as described above, i.e., employing the door, the case, and the hinge assembly between the door and the case as described above. The refrigeration apparatus may be a refrigerator, a freezer, a wine cooler, a freshness cabinet, and so on.

The above shows only an implementation of the present disclosure, and is not intended to limit the patent scope of the present disclosure. Any equivalent structure or equivalent process transformation, performed based on the contents of the specification and the accompanying drawings of the present disclosure, directly or indirectly applied in other related technical fields, shall be equivalently included in the scope of the present disclosure.

What is claimed is:

1. A case assembly, comprising:
a case, defining a receiving space having an opening;
a door, configured to block the opening;
a hinge assembly, disposed body at a pivot side of the case and configured to pivotally connect the case to the door;
wherein the door has an inner edge and an outer edge at the pivot side, the door has a first reference plane and a second reference plane; when the door is in a closed state relative to the case, the inner edge is located on and extend along the first reference plane, and the first reference plane is parallel to a plane in which the opening is located; when the door is in a closed state relative to the case, the outer edge is located on and extend along the second reference plane, and the second reference plane is perpendicular to the plane in which the opening is located, the first reference plane and the second reference plane stay stationary with respect to the case while the door is being opened with respect to the case;
a first hinge point and a second hinge point are formed on the hinge assembly; the second hinge point, compared to the first hinge point, is located further away from the outer edge; while the door is being opened, under an action of the hinge assembly, from a closed state with respect to the case to a position of a maximum opening angle with respect to the case, the first hinge point is configured to move from a starting position to a termination position, a point on the door is defined as a reference point, the reference point coincides with one of the starting position and termination position of the first hinge point, the coincided one of the starting position and termination position is located furthest away from the second reference plane, and the reference point is stationary with respect to the case while the door is being opened;
a first perpendicular line is generated from the reference point to the outer edge; the reference point has a first perpendicular distance, along the first perpendicular line, to the outer edge; a second perpendicular line is generated from the reference point to the inner edge; the reference point has a second perpendicular distance, along the second perpendicular line, to the inner edge; a third angle is generated between the first perpendicular line and the first reference plane, a fourth angle is generated between the second perpendicular line and the first reference plane;
when the door is being opened from the closed state to a position of a first opening angle relative to the case, each of the first perpendicular distance and the second perpendicular distance is gradually decreased, the third angle is within a range of 0 degrees to 90 degrees and is gradually decreased, and the fourth angle is in a range of 0 degrees to 90 degrees and is gradually increased.

2. The case assembly according to claim 1, wherein, as an opening angle between the door and the case being increased by each unit of angle, a change in the first perpendicular distance is gradually increased; and a change in the second perpendicular distance is gradually decreased.

3. The case assembly according to claim 2, wherein the first perpendicular distance is gradually decreased from a range between 0.63t and 0.65t to a range between 0.57t and 0.59t, the second perpendicular distance is gradually decreased from a range between 0.80 t and 0.78t to a range between 0.59t and 0.61t, and the t is a thickness of the door.

4. The case assembly according to claim 3, wherein the third angle is decreased gradually from a range between 39 degrees and 41 degrees to a range between 35 degrees and 37 degrees, and the fourth angle is increased gradually from a range between 49 degrees and 51 degrees to a range between 79 degrees and 81 degrees.

5. The case assembly according to claim 1, wherein a first product is obtained by multiplying the first perpendicular distance by a cosine of the third angle; and
when the door is being opened from the closed state to a position of a first opening angle relative to the case, a difference between a maximum value of the first product and a minimum value of the first product is less than 0.1t, and the t is a thickness of the door.

6. The case assembly according to claim 5, wherein the first product is constant or is gradually decreased.

7. The case assembly according to claim 1, wherein a second product is obtained by multiplying the second perpendicular distance by a sine of the fourth angle; and
when the door is being opened from the closed state to a position of a first opening angle relative to the case, a difference between a maximum value of the second product and a minimum value of the second product is less than 0.1t, and the t is a thickness of the door.

8. The case assembly according to claim 7, wherein the second product is constant or is gradually decreased.

9. The case assembly according to claim 1, wherein the hinge assembly comprises an outer shaft arranged on the case and an outer slot defined in the door, the outer slot and the outer shaft are engaged with each other to form the first hinge point, and the reference point coincides with a center of the outer shaft.

10. The case assembly according to claim 1, wherein the hinge assembly comprises an outer shaft arranged on the door body and an outer slot defined in the case, the outer slot and the outer shaft are engaging with each other to form the first hinge point, the reference point coincides with a center of the outer shaft when the outer shaft is located at the termination position in the outer slot.

11. The case assembly according to claim 1, wherein corresponding to the same opening angle between the door and the case, and the first perpendicular distance is less than the second perpendicular distance, and the third angle is less than the fourth angle.

12. The case assembly according to claim 1, wherein the hinge assembly comprises an inner shaft and an inner slot, the inner shaft is arranged on one of the case and the door, the inner slot is defined in the other one of the case and the door; and
when the door is in the closed state, the inner shaft is spaced apart from a wall of an end of the inner slot away from the inner edge.

13. The case assembly according to claim 1, wherein the hinge assembly comprises an inner shaft and an inner slot, the inner shaft is arranged on one of the case and the door, the inner slot is defined in the other one of the case and the door; and
when the door is at the position of the maximum opening angle with respect to the case, the inner shaft is spaced apart from a wall of an end of the inner slot near the inner edge.

14. A case assembly, comprising:
a case, defining a receiving space having an opening;
a door, configured to block the opening;
a hinge assembly, disposed body at a pivot side of the case and configured to pivotally connect the case to the door;
wherein the door has an inner edge and an outer edge at the pivot side, the door has a first reference plane and a second reference plane; when the door is in a closed state relative to the case, the inner edge is located on and extend along the first reference plane, and the first reference plane is parallel to a plane in which the opening is located; when the door is in a closed state relative to the case, the outer edge is located on and extend along the second reference plane, and the second reference plane is perpendicular to the plane in which the opening is located, the first reference plane and the second reference plane stay stationary with respect to the case while the door is being opened with respect to the case;
a first hinge point and a second hinge point are formed on the hinge assembly; the second hinge point, compared to the first hinge point, is located further away from the outer edge; while the door is being opened, under an action of the hinge assembly, with respect to the case, the door has a first movement direction with respect to the case at the first hinge point and has a second movement direction with respect to the case at the second hinge point; a first angle is generated between the first movement direction and the first reference plane, a second angle is generated between the second movement direction and the first reference plane; when the first movement direction is extending away from the first reference plane, the first angle is expressed as a positive value; when the first movement direction is extending away from the second reference plane, an absolute value of the first angle is less than 90 degrees; when the second movement direction is extending away from the second reference plane, the second angle is expressed as a positive value; when the second movement direction is extending away from the second reference plane, an absolute value of the second angle is less than 90 degrees;
while the door is being opened from the closed state to a position of a first opening angle relative to the case, the second angle is expressed as the positive value and is less than 90 degrees, the first angle is expressed as the positive value and is decreased gradually from a first initial angle, which is less than 90 degrees, to a first termination angle; a difference between the second angle and the first angle, corresponding to a same opening angle between the door and the case, is increased gradually.

15. A case assembly, comprising:
a case, defining a receiving space having an opening;
a door, configured to block the opening;
a hinge assembly, disposed body at a pivot side of the case and configured to pivotally connect the case to the door;
wherein the door has an inner edge and an outer edge at the pivot side, the door has a first reference plane and a second reference plane; when the door is in a closed state relative to the case, the inner edge is located on and extend along the first reference plane, and the first reference plane is parallel to a plane in which the opening is located; when the door is in a closed state relative to the case, the outer edge is located on and extend along the second reference plane, and the second reference plane is perpendicular to the plane in which the opening is located, the first reference plane and the second reference plane stay stationary with respect to the case while the door is being opened with respect to the case;
a first hinge point and a second hinge point are formed on the hinge assembly; the second hinge point, compared to the first hinge point, is located further away from the outer edge; while the door is being opened, under an action of the hinge assembly, from a closed state with respect to the case to a position of a maximum opening angle with respect to the case, the first hinge point is configured to move from a starting position to a termination position, a point on the door is defined as a reference point, the reference point coincides with one of the starting position and termination position of the first hinge point, the coincided one of the starting position and termination position is located furthest away from the second reference plane, and the reference point is stationary with respect to the case while the door is being opened;
a first perpendicular line is generated from the reference point to the outer edge; the reference point has a first perpendicular distance, along the first perpendicular line, to the outer edge; a second perpendicular line is generated from the reference point to the inner edge; the reference point has a second perpendicular distance, along the second perpendicular line, to the inner edge; a third angle is generated between the first perpendicular line and the first reference plane, a fourth angle is generated between the second perpendicular line and the first reference plane; and
when the door is being opened from a position of a first opening angle relative to the case to a position of a second opening angle relative to the case, the first perpendicular distance is gradually decreased; the third angle is within a range of 0 degrees to 90 degrees and is gradually decreased; the fourth angle, when the opening angle between the door and the case is within a predetermined angle range and before the second opening angle between the door and the case is reached, is gradually increased and exceeds 90 degrees; and the second perpendicular distance is gradually increased when the opening angle between the door and the case is within the predetermined angle range.

16. The case assembly according to claim 15, wherein the fourth angle is gradually increased from an angle of less than 90 degrees to an angle of greater than 90 degrees, and the second perpendicular distance is first gradually decreased and subsequently gradually increased.

17. The case assembly according to claim 16, wherein the first perpendicular distance is gradually decreased from a range between 0.57t and 0.59t to a range between 0.50t and 0.52t, the second perpendicular distance is within a range between 0.59t and 0.61t and is gradually increased, and the t is a thickness of the door.

18. The case assembly according to claim 17, wherein the third angle is decreased gradually from a range between 35 degrees and 37 degrees to a range between 2 degrees and 4 degrees; and the fourth angle is increased gradually from a range between 79 degrees and 81 degrees to a range between 125 degrees and 127 degrees.

19. The case assembly according to claim 15, wherein a second product is obtained by multiplying the second perpendicular distance by a sine of the fourth angle; and
when the door is being opened from the position of the first opening angle relative to the case to the position of the second opening angle relative to the case, the second product is gradually decreased when the opening angle between the door and the case is within the predetermined angle range.

20. The case assembly according to claim 19, wherein a difference between the second product corresponding to the door being at the second opening angle relative to the case and the second product corresponding to the door being at the first opening angle relative to the case is not greater than −0.1t, and the t is a thickness of the door.
